(19) United States
(12) Patent Application Publication
(10) Pub. No.: US 2014/0297348 A1
(43) Pub. Date: Oct. 2, 2014

(54) MERIT-BASED INCENTIVE TO-DO LIST APPLICATION SYSTEM, METHOD AND COMPUTER PROGRAM PRODUCT

(71) Applicant: David A. ELLIS, Perkasie, PA (US)

(72) Inventor: David A. ELLIS, Perkasie, PA (US)

(21) Appl. No.: 14/159,435

(22) Filed: Jan. 20, 2014

Related U.S. Application Data
(60) Provisional application No. 61/754,935, filed on Jan. 21, 2013.

(51) Int. Cl. G06Q 10/06

(52) U.S. Cl. CPC G06Q 10/063114
USPC 705/7.15; 705/7.13

(57) ABSTRACT

A system, method and/or computer program product may provide an application for managing a list of tasks, assignable by assignor to be performed by assignee. The method may provide a multi-platform application, including a method when executed on a processor include receiving a plurality of tasks to be performed, tracking completion, and tracking points associated with successful completion. Tasks may be assigned and confirmed completed by assignor, and performed by assignee. The system may include an point value system enabling redemption upon completion of tasks having point value. The point reward system may be integrated with other technologies to dispense exemplary currency or other benefit. The method may include: receiving, by processor, a plurality of tasks; and managing, a point system associated with completion of a task. The system may provide steps of how to perform a task. The system may provide proof of accomplishment, initiation, or completion of a task. The system may receive and/or provide an assessment of an assignor of the completion of the task.

### CROSS REFERENCE TO RELATED APPLICATION

The present invention claims priority to and benefit under 35 USC Section 119(e) of a U.S. Provisional Patent Application Ser. No. 61/754,935, filed Jan. 21, 2013, confirmation no. 6414, the contents of all of which are incorporated herein by reference in their entirety, and of common assignee to the present invention.

### BACKGROUND OF THE INVENTION

1. Field of the Invention

The present invention relates generally to time management, and more particularly to electronic time management.

2. Discussion of the Related Art

Conventionally, various systems have existed for managing a user's time. A task list is a conventional time management tool.

Time management is the act or process of planning and exercising conscious control over the amount of time spent on specific activities, especially to increase effectiveness, efficiency and/or productivity. Time management may be aided by a range of skills, tools, and techniques used to manage time when accomplishing specific tasks, projects and goals complying with a due date. This set encompasses a wide scope of activities, and these include planning, allocating, setting goals, delegation, analysis of time spent, monitoring, organizing, scheduling, and prioritizing. Initially, time management referred to just business or work activities, but eventually the term broadened to include personal activities as well. A time management system is a designed combination of processes, tools, techniques, and methods. Usually time management is a necessity in any project development as it determines the project completion time and scope.

A task list (also to-do list or things-to-do) is a list of tasks to be completed, such as chores or steps toward completing a project. The task list is an inventory tool which serves as an alternative or supplement to memory.

Task lists are used in self-management, grocery lists, business management, project management, and software development. Task lists may involve more than one list.

When one of the items on a task list is accomplished, the task is normally checked or crossed off. The traditional method is to write these on a piece of paper with a pen or pencil, usually on a note pad or clip-board.

Numerous digital equivalents are now available, including personal information management (PIM) applications and most personal digital assistants (PDAs). There are also several web-based task list applications, many of which are free.

### Personal Information Managers (PIMs)

A personal information manager (PIM) (often referred to as a PIM tool or, more simply, a PIM) is a type of application software that functions as a personal organizer. The acronym PIM is now, more commonly, used in reference to personal information management as a field of study. As an information management tool, a PIM tool's purpose is to facilitate the recording, tracking, and management of certain types of “personal information.” PIMs are often used to track personal information, which can include any of the following: personal file collections (e.g., digital and physical documents, music, photos, videos, etc.), personal notes/journal entries, address books, lists (including task lists), significant calendar dates birthdays, anniversaries, appointments and meetings, reminders, electronic mail (email), instant messages (IMs), fax communications, voicemail, project management features, real simple syndication (RSS) feeds, etc., alerts, references (including scientific references, websites of interest), etc.

In recent times, time management and communications functions of PIMs have largely migrated from PDAs to smartphones, with RIM (Research In Motion), Apple (iPhone, iPad, etc.), Google (Android based devices such as the Samsung Galaxy S3, etc.) and others all manufacturing smartphones that offer most if not all of the functions of earlier PDAs. The convergence of many communications technologies, including telephone, email, social media, news and journalism, and radio transmission, in a compact, ubiquitous device, along with the ability of these devices to create, transmit and publish voice, text, photos and video almost instantaneously is a development that many social commentators expect will revolutionize the way humans interact with each other, and with government and media.

### Task List Organization

Task lists are often tiered. The simplest tiered system may include a general to-do list (or task-holding file) to record all the tasks the person needs to accomplish, and a daily to-do list which is created each day by transferring tasks from the general to-do list. Task lists are often prioritized.

For example, an early advocate of “ABC” prioritization was Alan Lakein. In his system “A” items were the most important (“A-1” the most important within that group), “B” next most important, “C” least important. A particular method of applying the ABC method assigns “A” to tasks to be done within a day, “B” a week, and “C” a month. To prioritize a daily task list, one either records the tasks in the order of highest priority, or assigns them a number after they are listed (“1” for highest priority, “2” for second highest priority, etc.) which indicates in which order to execute the tasks. The latter method is generally faster, allowing the tasks to be recorded more quickly. Another way of prioritizing compulsory tasks (group A) is to put the most unpleasant one first. When it's done, the rest of the list feels easier. Groups B and C can benefit from the same idea, but instead of doing the first task (which is the most unpleasant) right away, it gives motivation to do other tasks from the list to avoid the first one.

A completely different approach which argues against prioritizing altogether was put forward by British author Mark Forster in his book “Do It Tomorrow and Other Secrets of Time Management.” This is based on the idea of operating “closed” to-do lists, instead of the traditional “open” to-do list. He argues that the traditional never-ending to-do lists virtually guarantees that some of your work will be left undone. This approach advocates getting all your work done, every day, and if you are unable to achieve it helps you diagnose where you are going wrong and what needs to change.

Various writers have stressed potential difficulties with to-do lists.

Management of the list can take over from implementing it. This could be caused by procrastination by prolonging the planning activity. This is akin to analysis paralysis. As with any activity, there's a point of diminishing returns.

Some level of detail must be taken for granted for a task system to work. Rather than put “clean the kitchen,” “clean the bedroom,” and “clean the bathroom,” it is more efficient to put “housekeeping” and save time spent writing and reduce the system's administrative load (each task entered into the system generates a cost in time and effort to manage it, aside from the execution of the task). The risk of consolidating tasks, however, is that “housekeeping” in this example may prove overwhelming or nebulously defined, which will either increase the risk of procrastination, or a mismanaged project.

Listing routine tasks wastes time. If you are in the habit of brushing your teeth every day, then there is no reason to put it down on the task list. The same goes for getting out of bed, fixing meals, etc. If you need to track routine tasks, then a standard list or chart may be useful, to avoid the procedure of manually listing these items over and over.

To remain flexible, a task system must allow for disaster. An entity must be ready for a disaster. Even if it is a small disaster, if no one made time for this situation, it can metastasize, potentially causing damage to the entity.

To avoid getting stuck in a wasteful pattern, the task system should also include regular (monthly, semi-annual, and annual) planning and system-evaluation sessions, to weed out inefficiencies and ensure the user is headed in the direction he or she truly desires.

If some time is not regularly spent on achieving long-range goals, the individual may get stuck in a perpetual holding pattern on short-term plans, like staying at a particular job much longer than originally planned.

### Software Applications

Modern task list applications may have built-in task hierarchy (tasks are composed of subtasks which again may contain subtasks), may support multiple methods of filtering and ordering the list of tasks, and may allow one to associate arbitrarily long notes for each task.

In contrast to the concept of allowing the person to use multiple filtering methods, at least one new software product additionally contains a mode where the software attempts to dynamically determine the best tasks for any given moment.

Many of the software products for time management support multiple users. They allow the person to give tasks to other users and use the software for communication

In law firms, for example, law practice management software may also assist in time management.

Task list applications may be thought of as lightweight personal information manager or project management software.

Conventional task list methods and systems have various shortcomings. What is needed is an improved system and method that overcomes the various shortcomings of conventional solutions.

### SUMMARY OF VARIOUS EXEMPLARY EMBODIMENTS OF INVENTION

Various exemplary embodiments of a system, method and computer program product for providing an merit-based incentive to-do list application, system, method and/or computer program product as is set forth in detail herein.

According to one exemplary embodiment, a computer implemented method, system, and/or computer program product executable on a computer processor to cause a to-do list application method may include, according to an exemplary embodiment, an exemplary applet based to-do list application.

According to one exemplary embodiment, a computer implemented system, method and/or computer program product may provide an application for managing a to-do list of activities, assignable by an assigning user, and performable by a performing user.

The method according to one exemplary embodiment may provide a multi-platform application, which may include a method when executed on a computer processor may include receiving a plurality of tasks to be performed, tracking completion of the plurality of tasks, and tracking points associated with successful completion of the plurality of tasks.

In one exemplary embodiment, the plurality of tasks may be assigned by the assigning user, and the plurality of tasks may be performed by the performing user.

According to one exemplary embodiment, the system may include an exemplary reward system. According to one exemplary embodiment, the reward system may be adapted to be integrated with other technologies to dispense exemplary currency and/or benefits associated with the reward system.

According to an exemplary embodiment, a method may include: a computer-implemented method, which may include: receiving, by at least one computer processor, a plurality of tasks, wherein each of said plurality of tasks is assigned by an assignor to be performed by an assignee; and managing, by the at least one computer processor, a point system associated with completion of said plurality of tasks.

According to one exemplary embodiment, the method may include: wherein the assignor comprises at least one of: a guardian; a boss, or a parent, and wherein the assignee comprises at least one of: a dependent; an employee; or a child.

According to one exemplary embodiment, the method may include: wherein said receiving said plurality of said tasks comprises at least one of: receiving, by the at least one computer processor, a numeric value associated with task; or receiving, by the at least one computer processor, data about each task of said plurality of tasks.

According to one exemplary embodiment, the method may include: wherein said managing comprises at least one of: maintaining, by the at least one computer processor, a point balance associated with each assignee; receiving, by the at least one computer processor, at least one indication of an adjustment to said point balance comprising at least one of: receiving, by the at least one computer processor, at least one point value adjustment associated with at least one assignee, upon completion of at least one task of said plurality of tasks; or receiving, by the at least one computer processor, an adjustment to said point balance comprising at least one of: at least one indication of at least one credit to the balance of at least one assignee; or at least one indication of at least one debit to the balance of at least one assignee; or storing, by the at least one computer processor, said point balance.

According to one exemplary embodiment, the method may further include: receiving, by the at least one computer processor, a request to transfer at least a portion of points of said point system.

According to one exemplary embodiment, the method may include: wherein said receiving said request to transfer points comprises at least one of: receiving, by the at least one computer processor, a request to exchange points for a wish list item; receiving, by the at least one computer processor, a request to gift points by a first assignee to second assignee; receiving, by the at least one computer processor, a request to gift points within a group or family; receiving, by the at least one computer processor, a request to buy intragroup or intrafamily value goods or services; receiving, by the at least one computer processor, a request to trade points within a group or family for a value; or receiving, by the at least one computer processor, a request to convert at least a portion of said point system value to a monetary spend equivalent value comprising at least one of: receiving, by the at least one computer processor, a request to convert at least a portion of said point system value into a gift card value; receiving, by the at least one computer processor, a request to convert at least a portion of said point system value into a third party payer equivalent value; or receiving, by the at least one computer processor, a request to convert at least a portion of said point system value into at least one of: a prepaid online account value; a prepaid account value; a merchant account value; a merchant account bank card value; a merchant account debit card value; or a merchant account charge or credit card value.

According to one exemplary embodiment, the method may include: wherein said receiving said request to transfer comprises: receiving a request to transfer at least a portion of said point system value for at least one of: an intragroup good or service; or an intrafamily good or service.

According to one exemplary embodiment, the method may include: wherein said intragroup or said intrafamily goods or services comprise at least one of: a chore; a communication device; a computing device; a networked device; a wireless network device; a gaming device; a time period or duration of use of a communication device; a time period or duration of use of a computing device; a time period or duration of use of a networked device; a time period or duration of use of a wireless network device; a time period or duration of use of a gaming device; time period or duration with a toy; a time period or duration of use of with a screen device; a time period or duration of use of with a device; a time period or duration of use of with a friend; a time period or duration of use of with a parent; a time period or duration of use of with an individual; a time period or duration of use of with a group; or a time period or duration of use of with a tool.

According to one exemplary embodiment, the method may further include: receiving, by the at least one computer processor, a request to receive in a table an indication of a point value associated with a given task.

According to one exemplary embodiment, the method may further include: communicating with a third party comprising at least one of a partner, a provider, a vendor, a merchant, an advertiser, or an assignor; wherein said communicating comprising at least one of: providing access by the third party to at least one of: at least one wish list; at least one point balance; at least one relevant task; at least one wish list of the assignee; at least one point balance of the assignee; at least one relevant task of the assignee; at least one wish list of the assignor; at least one point balance of the assignor; at least one relevant task of the assignor; at least one wish list of the third party; at least one point balance of the third party; or at least one relevant task of the third party; receiving instructional content; receiving instructional content on how to perform an associated task; receiving instructional content from the third party; receiving instructional content from an assignor; receiving instructional content from another assignor; receiving a request to transfer at least a portion of a point system value; receiving a request to transfer at least a portion of a point system value in exchange for a 3P partner value; receiving a request to transfer at least a portion of a point system value into an online commerce company gift card value; or receiving at least one of: a coupon, an offer, a deal, a bid, a discount from at least one of: a merchant, an online merchant, an offline merchant, or a 3rd party online partner.

According to one exemplary embodiment, receiving an instructional video may include, e.g., but not limited to, a video instructing how to brush teeth, etc.

According to one exemplary embodiment, the method may include: wherein said receiving said plurality of tasks comprises: receiving a request to create at least one of said plurality of tasks.

According to one exemplary embodiment, the method may include: wherein said receiving a plurality of tasks comprises: receiving a request to create at least one task comprising at least one: receiving a request to receive or capture content of a given task comprising at least one of: media, multiple content, image, video, audio, multimedia, text, hyper text, file, text instructions, or picture; receiving a request to receive or capture content of proof of completion of a given task comprising at least one of: receiving a request to authenticate comprising capturing proof of completion by the assignee or the assignor; receiving a request to verify by the assignee or the assignor; receiving a request to acknowledge completion by the assignee or the assignor; or receiving a request to confirm by the assignee or the assignor; or receiving a request to receive or capture at least one instruction related to a given task, comprising at least one of: capturing from at least one of: the assignor; or another assignor; or capturing from a third party comprising at least one of: an assignor; another assignor; or vendor.

According to one exemplary embodiment, the method may further include: receiving a request to convert at least a portion of said point system value into a monetary value, and further comprising: providing at least one of: providing at least one controlled account with preauthorization rules of restrictions for usage of said monetary value; or providing at least one non-controlled account with no restrictions on use.

According to one exemplary embodiment, the method may include: wherein said receiving a plurality of tasks comprises: receiving a request to assign at least one task by the assignor to at least one assignee of said plurality of assignees comprising: receiving a request to assign the at least one task to a plurality of assigned assignees of said plurality of assignees comprising at least one of: receiving a request to capture which at least one assigned assignee of a plurality of assignees are assigned to the at least one task; receiving a request to capture or assign at least one of said plurality of assigned assignees assigned as task leader of said plurality of assigned assignees; or receiving a proportional division of points for each of said plurality of assigned assignees.

According to one exemplary embodiment, the method may further include: receiving a request to capture comprising at least one of: receiving a request to capture at least one positive action; or receiving a request to capture at least one negative action.

According to one exemplary embodiment, the method may include: wherein said at least one negative action comprises at least one of: receiving a request to capture at least one habitual action or a list of habitual action or unwanted behavior by at least one offending assignee and to associate a negative point value to each of said at least one habitual action; receiving a request to capture from the assignor at least one specific instance of said at least one habitual action or unwanted behavior, or any item on the list of habitual action or unwanted behavior; receiving a request to capture evidence of at least one instance of said at least one habitual action or unwanted behavior through at least one form of content comprising at least one of: a media, a multiple content, an image, a video, an audio, a multimedia, a text, a hyper text, a file, a text instruction, a picture, a voice, receiving a request to deduct the associated negative point value from the offending assignee; or receiving a request to notify the offending assignee of a specific instance of said at least one habitual action or unwanted behavior and the associated negative point value.

According to one exemplary embodiment, the method may include: wherein said receiving a request to capture of at least one positive action by assignees comprises at least one of: receiving a request to capture an ad hoc or other observation of performance of an instance of a positive, non-assigned task by an assignee; receiving a request to capture an observation of an instance of a positive action of the assignee that demonstrates a behavior of deserved merit; receiving a request to deposit points, or depositing in a points system account of the assignee of a points system value received from the assignor; or receiving a request to notify or notifying the assignee of the specific instance of positive behavior and the points system value received by the assignor.

According to one exemplary embodiment, the method may further include: receiving a request to modify points system value for a given task comprising at least one of: receiving a base point value for said given task; receiving rules that may modify the base point value for said given task; storing rules in at least one database table; comparing rules with the outcome of the task; calculating a modification to the baseline point value for said given task; displaying the modified point value for said given task to at least one of the assignee, or assignor; receiving an adjustment of the assignor to the base or modified point value of said given task of the assignee resulting in the final point value of said given task; or depositing the final point value of said given task in the points value system account of the assignee.

In one exemplary embodiment, comparing rules may include comparing whether performance of the task was completed before, by, or after a task deadline, etc.

According to one exemplary embodiment, the method may further include: receiving or providing a status of a given task comprising at least one of: receiving or providing a current status of at least one or all tasks; comparing the status of at least one or all tasks with a table of at least one rule; performing at least one calculation based on at least one rule; capturing at least one time stamp; measuring time between at least two time stamps of a status change of at least one task; displaying at least one message; or sending at least one reminder or alert based on at least one rule associated with the status.

According to an exemplary embodiment, a system comprising: at least one memory; and at least one processor coupled to said at least one memory, wherein said at least one processor is adapted to: receive a plurality of tasks, wherein each of said plurality of tasks is assigned by an assignor to be performed by an assignee; and manage a point system associated with completion of said plurality of tasks.

According to an exemplary embodiment, a computer program product embodied on a computer accessible medium, comprising program logic, which when said program logic is executed on at least one computer processor performs a method comprising: receiving, by at least one computer processor, a plurality of tasks, wherein each of said plurality of tasks is assigned by an assignor to be performed by an assignee; and managing, by the at least one computer processor, a point system associated with completion of said plurality of tasks.

Further features and advantages of the invention, as well as the structure and operation of various exemplary embodiments of the invention, are described in detail below with reference to the accompanying drawings.

### BRIEF DESCRIPTION OF THE DRAWINGS

The foregoing and other features and advantages of the invention will be apparent from the following, more particular description of an embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1A depicts an exemplary view of an exemplary embodiment of an exemplary heterogeneous client device environment coupled to an exemplary network system adapted to provide a merit-based incentive to-do list application system architecture environment using a plurality of computing and/or communication devices coupled together in a distributed networked system architecture, according to an exemplary embodiment;

FIG. 1B depicts an exemplary embodiment of an exemplary, but not limited, network-based merit-based incentive to-do list application system, method and/or computer program product, system architecture high level diagram, according to an exemplary embodiment coupled together by an exemplary cloud-based architecture network, according to an exemplary embodiment;

FIG. 1C depicts an exemplary embodiment of an exemplary system illustrating an exemplary distributed user and service provider network environment;

FIG. 1D depicts an exemplary embodiment of an exemplary system illustrating an exemplary distributed network environment;

FIG. 2 depicts an exemplary embodiment of an exemplary screenshot of an exemplary user interface (UI) illustrating an exemplary to-do list application program for managing and tracking an exemplary list of a plurality of tasks (e.g., previously assigned by an exemplary assigning user or assignor, e.g., but not limited to, a parent) to be performed by a performing user or assignee (e.g., but not limited to, a child, etc.), according to one exemplary embodiment;

FIG. 3 depicts an exemplary embodiment of an exemplary screenshot of an exemplary user interface (UI) illustrating an exemplary application program of an exemplary assigning user, by which the assigning user or assignor (e.g., but not limited to, a parent) may assign one or more tasks to a task list to be performed by the performing user or assignee (e.g., but not limited to, a child, etc.);

FIG. 4A depicts an exemplary flow diagram, according to an exemplary embodiment illustrating an exemplary computer implemented process of managing completion of a list of tasks assigned to a given performing user, by an assigning user, according to an exemplary embodiment;

FIG. 4B depicts an exemplary flow diagram, according to an exemplary embodiment illustrating an exemplary computer implemented process of creating a task list and/or one or more rewards by an assigning user, according to an exemplary embodiment;

FIG. 4C depicts an exemplary screenshot of an exemplary user interface (UI) illustrating an exemplary application program for among other things displaying an exemplary current balance of points for an exemplary points value system; an exemplary interface for adding exemplary negative point value and/or exemplary positive point value to an exemplary base value, to obtain an exemplary final point value; and exemplary functionality to convert points system value into, e.g., exemplary monetary value, etc.; and

FIG. 5 depicts an exemplary diagram illustrating an exemplary computer/communications device hardware architecture as may be used in various components of exemplary embodiments of the present invention, according to an exemplary embodiment.

### DETAILED DESCRIPTION OF EXEMPLARY EMBODIMENTS OF THE INVENTION

Various exemplary embodiments of the invention are discussed in detail below. While specific exemplary embodiments are discussed, it should be understood that this is done for illustration purposes only. Exemplary means example for purposes of this application, and various embodiments need not include all features as described herein. A person skilled in the relevant art will recognize that other components and configurations can be used without parting from the spirit and scope of the invention.

### Overview of Exemplary Embodiments

According to an exemplary embodiment, a task assigning user (e.g., but not limited to, a parent) may face several challenges in getting a performing user (e.g., but not limited to, a child, or teenager) to complete a group of assigned tasks. Often, communication of the tasks is inadequate, and inadequate recollection of the tasks by the performing user, can lead to a failure of the performing user completing tasks as assigned. According to one exemplary embodiment, a novel, nonobvious approach to assigning and managing tasks to be performed by another user is providing according to one exemplary embodiment.

In an exemplary embodiment, an improved system, method and/or computer program product may be provided to manage the task of assigning tasks, managing completion of the tasks, and creating and managing a merit-based incentive system to encourage completion of the tasks, and to provide a reward system to help reach the goals of the assigning user assigning tasks to the performing user.

According to an exemplary embodiment, one or more exemplary apparatus(es), device(s), method(s), and/or business method(s) are set forth, which may be used by an exemplary assigning user such as, e.g., but not limited to, a parent, a manager, an employer, a supervisor, a superior, etc., to assign one or more tasks to an exemplary performing user such as, e.g., but not limited to, a child, a teenager, an employee, a rank and file member, etc. to manage assignment, completion and an incentive/reward system, according to an exemplary embodiment.

According to an exemplary embodiment, the method may include receiving from the assigning user a list of one or more tasks, associating the tasks with a given task list or to-do list, managing tracking of completion of the task list by the performing user, and managing an incentive reward system for driving completion of the assigned tasks.

According to an exemplary embodiment, a given completed task may result in a reward currency or other benefit being generated and/or earned, and access to the currency may be metered out to the performing user via any of several exemplary methods.

In one exemplary embodiment, technology aids may be coupled to the reward system to enable an integrated system to access reward and/or benefit via exemplary electronic access. One exemplary embodiment of the invention may include receiving any authorization of an individual's payment method (such as, e.g., but not limited to, a credit card) for a monetary amount (i.e. price) of the current tier a multi-tier thread is at, followed by the charging of the variable amount (tier) the thread may reach upon expiration of the dynamic countdown generated by the first buyer (creator) of the thread.

One exemplary embodiment of the invention may include tracking of a non-monetary indicia of task completion. An exemplary point system, referred to, in an exemplary embodiment as so-called Karma points, may enable creating a benefit currency that may be redeemed in any of various exemplary methods.

### Exemplary Parent-Child Environment

According to one exemplary, but non-limiting environment, an exemplary Didjadoo system, method and/or computer program product may be used by an exemplary parent to achieve getting the parent's kids to “get their stuff done, without all the noise.”

Applicant recognized, as a father of four kids ranging in age from five to fifteen, that Applicant was always giving orders and reminders to children, to, e.g., but not limited to, clean up after a meal, pick up a wet towel, to make their bed, empty the dishwasher, and/or to put away their clean laundry, etc. The Applicant also recognized that he generally has to give the kids treats when they do good things, as well as discipline them when things don't go so well. Conventionally, Applicant realized that it is a full-time, never-ending, continuous do-loop. Applicant sought to create a tool for control, process and automation.

According to one exemplary embodiment, a system, method and/or computer program product for enabling task assignment, and completion management, designed to aid in an automated interactive application tailored to facilitate management of child rearing task completion, and award redemption tool. According to one exemplary embodiment, the system, method and/or computer program product may be referred to as a Didjadoo service, being made available from David A. Ellis, of West Simsbury, Conn. USA, the first child rearing tool for the app-age.

While there are hundreds of “to-do” apps available such as, e.g., but not limited to, 2Do from Guided Ways Technologies Ltd, Toodledo, from Toodledo, List Master from List Logic Software, Packing and Packing Pro, from Quin Genzel, To-Do List Pro-Time Tracker, from Concrete Software, iProcrastinate Mobile, from Craig Otis, eTodo from bitAlpha, A Check List, available from Golden Trout Software, Zenbe Lists, available from Zenbe, reQall, from QTech, Inc., Today Todo Pro, from Spielhaus, all of which are accessible from the iTunes Store. However, with all the many to-do list application programs, conventionally available, none are made specifically to teach children the right way to get a task done, to reward or to discipline them accordingly, and to take the chaos and exasperation by the parents out of getting the tasks completed by the kid.

An exemplary Didjadoo service, according to an exemplary embodiment of the present invention, may include a multi-platform app, or application program, or applet, which may enable parents to create tasks, assign them to the parents' children with instructions, deadlines, and quality expectations.

According to an exemplary embodiment, children may receive exemplary tasks, which may be made to appear, by the exemplary system, method, and/or computer program product, according to an exemplary embodiment, on the electronic devices of the child (e.g., but not limited to, on an iPod, an iPod Touch, an iPhone, an Android device, a Mac, a PC, a tablet, an iPad, a smart television, a smart device, a smart car, a smart appliance, a notebook, a computer, a communications device, a mobile phone w/text, a smartphone, a personal digital assistant (PDA), a mobile phone, an Internet browser application, a standalone application, a set top box, a television receiver, a smart television, and/or any of various exemplary but not limiting devices, etc.) and may update the status of the child's assigned tasks (e.g., but not limited to, in-progress, complete, take a picture, etc.).

According to an exemplary embodiment, parents may receive task updates on their electronic devices (e.g., as described above with reference to kids' devices), whereby they can choose to inspect the quality of the completed task or rely on the child's assessment and picture.

### Karma Points

According to an exemplary embodiment, the exemplary parent (or other assignor) can then issue Karma Points (or other exemplary point system value) to the child's (or other assignee's) account, which can be saved and, e.g., but not limited to, be exchanged for exemplary valuable benefit such as, e.g., but not limited to, conversion to money, time, activities, and/or tangible rewards such as unlock codes for game systems, (e.g. XBOX), on-line gift cards, money, movie tickets, Daddy Date, slumber party or anything else with which a parent would desire to reward good behavior. Alternatively, Karma Points, according to an exemplary embodiment, can be reduced when task deadlines are missed, for poor quality work (e.g. jamming their clothes under the bed instead of hanging them in a closet), or for bad behavior (talking back, swearing, fighting, bad grades, lying, etc) all of which can be customized by the parent, according to an exemplary embodiment.

According to an exemplary embodiment, tasks can be pulled from a pre-made list, or created from scratch, allowing the parent to modify variables such as, e.g., but not limited to, due date, periodicity, quality, task owner(s), and/or Karma Level (what the task is worth), etc. Additionally, according to an exemplary embodiment, “repeat offenders” can be called up from a quick list so parents can quickly note an issue.

An example, according to an exemplary embodiment, may include, e.g., but not limited to, if a child always leaves their wet towel on the bathroom floor; then the child's parent may tap the child's name, “Towel on floor” and may potentially snap a picture, according to an exemplary embodiment. The child may be notified on their device of their “offense” with proof (e.g., the photo), along with an associated the deduction of Karma.

Alternatively, according to another exemplary embodiment, a child can perform an unassigned task, may document the tasks' completion (e.g., picture, voice note, etc.) and may submit it for potential Karma points, according to an exemplary embodiment. This would teach being proactive; an invaluable lifeskill.

The Applicants' father often said, “I shouldn't have to tell you everything.” Part of doing things right is providing thorough instructions, which may include examples of what a good job looks like. Didjadoo, according to another exemplary embodiment, allows uploading of instructions along with reference pictures. For younger children, tasks should or may be pictorial, such as, e.g., but not limited to, image, visual, and/or audio based content, etc., according to another exemplary embodiment. An example may include, according to another exemplary embodiment, showing a picture of how the bathroom sink should look when it is properly cleaned.

According to another exemplary embodiment, key steps may be highlighted, such as, e.g., but not limited to, “sink bowl wiped clean.” Parents and/or other assignors, may often be guilty of yelling “clean your room” without ever really teaching their child or other assignee how to do the task correctly.

Now, according to another exemplary embodiment, a child (assignee) with the references right in their hand, can meet and beat their parents' (assignor's) expectations.

According to another exemplary embodiment, parents and children can look at reports to see how they are doing (% complete, quality, pro-activeness, Repeat Offender trend, changes to Karma, etc.)

Ideally, Didjadoo, according to an exemplary embodiment, may further interact with other apps such as, e.g., but not limited to, family calendars (e.g. Cozi), iCal, location services, to allow parents and children to plan the tasks with their activities in mind. According to another exemplary embodiment, Didjadoo may take voice commands, via voice recognition software. According to another exemplary embodiment, via voice synthesis, Didjadoo may provide verbal step by step instructions and entered by the assigning user, when the performing user proceeds through an exemplary task list.

Didjadoo, according to another exemplary embodiment, may assume pervasive use of hand-held devices that run IOS or Android. For kids with basic mobile and text plans, they may be able to receive exemplary simple message system (SMS) text messages with tasks and may reply back with completed status, according to another exemplary embodiment. The ability to perform similar functions on a desktop, portable, mobile device, Mac, PC, thin client, fat client, ultrabook, and/or Netbook may be provided in an exemplary web browser and/or application, and/or applet, and/or app, according to another exemplary embodiment.

As noted, unlock codes, according to another exemplary embodiment, be able to be generated as part of an exemplary reward system. According to one exemplary embodiment, an exemplary separate, but potentially integrated and/or coupled technology (“PlugBug”) may be provided, which, according to another exemplary embodiment, may control the power to, e.g., but not limited to, an exemplary game console, computer, and/or other device, such as, e.g., but not limited to, any other electronically powered device such as, e.g., but not limited to, a TV, a computer, a radio, an electronic device, as may be as dictated by the Didjadoo codes. The Didjadoo codes, according to another exemplary embodiment, may expire when used. The code may be associated with an exemplary embedded algorithm that may tell the device how long to pass power. Ideally, the child's device may communicate with the power device to unlock codes and/or report time of play to the parents device via, e.g., but not limited to, blue tooth, WIFI, and/or other wireless and/or wired communications link. According to one exemplary embodiment, an exemplary system may interface using industry standard wireless protocols including Zigbee protocol compliant, based and enabled devices, and/or bluetooth and/or WiFi or other wireless device communications technologies to permit access via application control to externally powered devices via exemplary interface devices.

According to another exemplary embodiment, Didjadoo Karma Points may be essentially an alternative currency and can be, e.g., but not limited to, traded, donated, redeemed and/or gifted between users. An exchange rate may be established by the parents to create value in the real world, according to another exemplary embodiment. Partnerships with online retail sites that kids frequent may provide incentives for children to use their reward points via exemplary “Didjadoolar” accounts on, e.g., but not limited to iTunes store, Google Play, Amazon, an online savings accounts, and/or other ecommerce site and/or application purchasing depot, etc.

According to another exemplary embodiment, Didjadoo may ensure, no drama; no yelling; no trying to recall what was said or what was done. According to another exemplary embodiment, parents assign tasks. According to another exemplary embodiment, children complete the tasks. Good behavior may be rewarded while discipline is tied to specific, clear expectations, according to another exemplary embodiment. Over time, good habits are taught and reinforced while bad habits will systematically be eliminated, according to another exemplary embodiment. According to another exemplary embodiment, “spare this app; and spoil the child!”

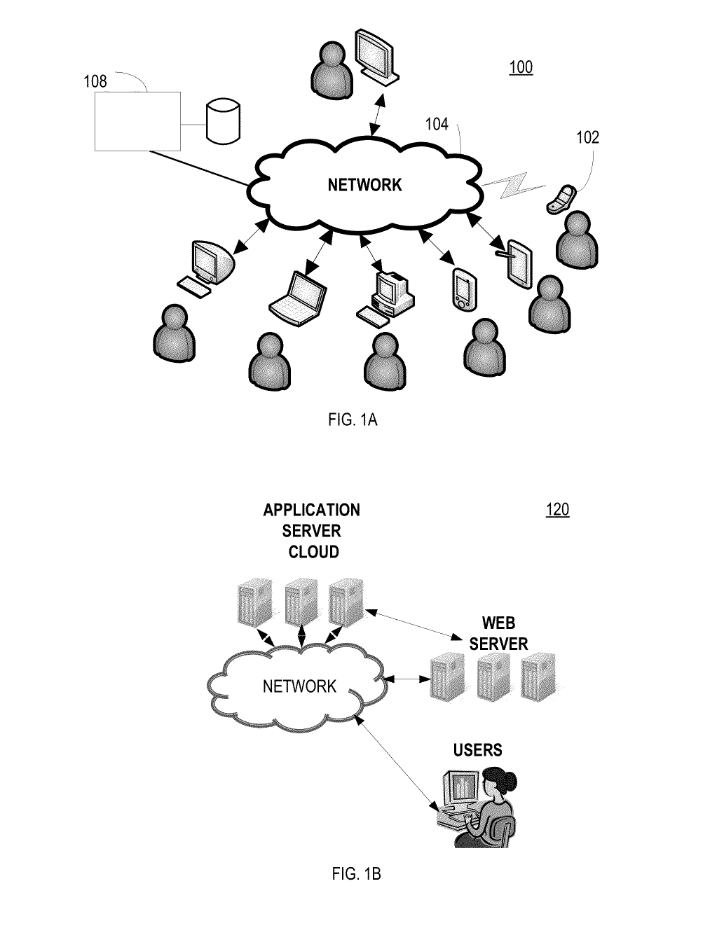

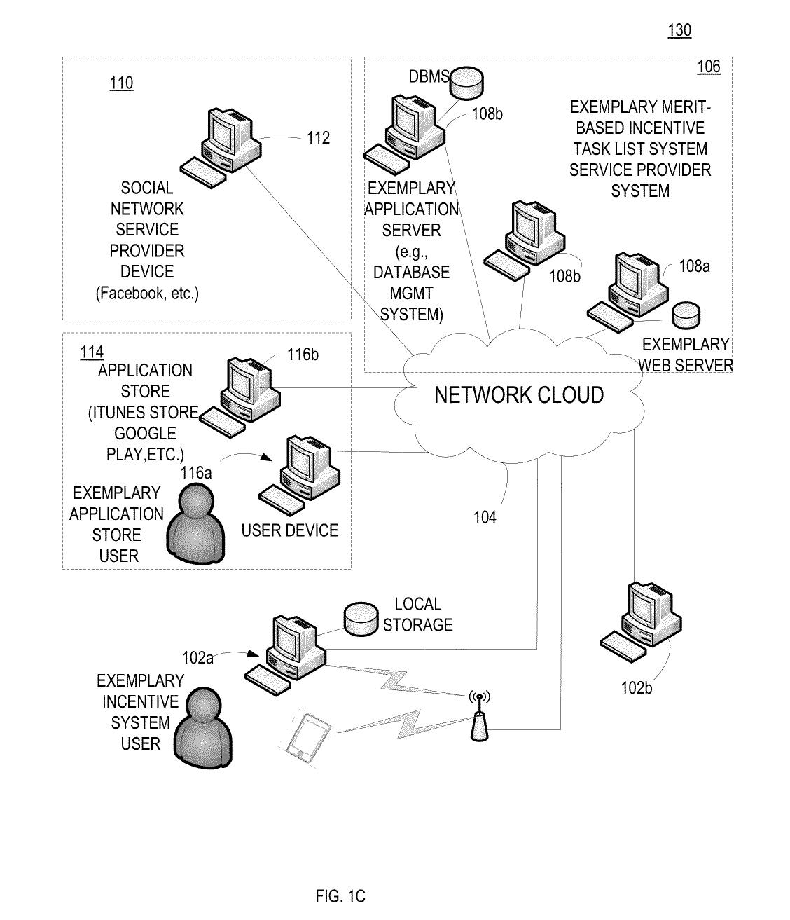

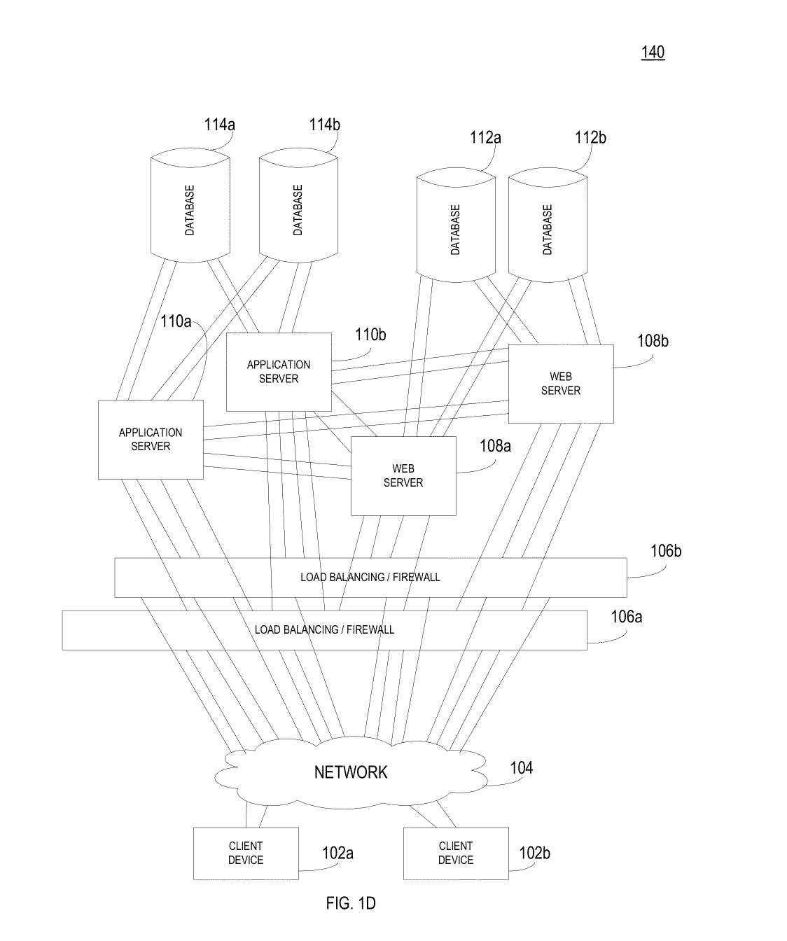

FIG. 1A depicts an exemplary view of an exemplary embodiment of an exemplary heterogeneous client device environment coupled to an exemplary network system adapted to provide a network-based merit-based incentive to-do list system architecture environment including a plurality of computing and/or communication devices coupled together in a distributed networked system architecture 100, according to an exemplary embodiment.

An exemplary computer system platform executing an exemplary software application program, which may reside, in an exemplary embodiment, on an exemplary user's client computing and/or communications device 102, and/or on a server 108 in interactive communication over an exemplary network 104 with the user's client computing device 102 in a client/server, hierarchical, terminal server, or peer-to-peer fashion, may include, but is not limited to, a computing or communications device, desktop/laptop computers, tablet computers, personal digital assistant, telephony, smart-phone, mobile device, mobile phone, wireless device, tablet, personal digital assistant, handheld and the like, which may in an exemplary embodiment, be the device capable of providing user display or other output and receiving input from user interactive selections via any of various well known input devices, for creation of task lists by assigning users (e.g., parents) and receipt of tasks, instructions, etc., by performing users through various ways via the user's computing device. According to an exemplary embodiment, various versions of the exemplary software program, which may be an applet, an app, an iOS app, an Android app, a Windows 7/8/n+ app, a standalone application program, a browser-based user interface, an Internet-browser-based interface, a Java applet, among various other embodiments as will be apparent to those skilled in the art, and as discussed further below with reference to FIGS. 1A-5, according to various exemplary embodiments.

In an exemplary embodiment, exemplary screen shots may be exemplary, but not limiting browser-based interactive interfaces, or an application or applet, such as a toolbar, or browser based toolbar. In another exemplary embodiment, the toolbar may be an applet, or other application program that may be provided in any of various well known ways, such as, e.g., but not limited to, an Internet browser-based toolbar, a JAVA applet, an ANDROID application, a Windows 7 or Windows 8, etc. application program, an iPOD, iPhone, or iPAD application, a MAC OS/X application, an iOS application, or the like, etc.

FIG. 1B depicts an exemplary embodiment of a network-based promotion system, system architecture high level diagram 120, according to an exemplary embodiment coupled together by an exemplary cloud-based architecture network, according to an exemplary embodiment.

According to an exemplary embodiment an exemplary cloud/network system and software, or a remote client server topology, a world wide web based (WWW) internet browser based application, or the like application may be provided. Users as shown in diagram 120 may access applications, in an exemplary embodiment via a network illustrated by the cloud, which may include, for example web servers such as, e.g., but not limited to, domain name servers (DNS) servers capable of domain name resolution, and hyper text markup language (HTML), JAVA applications, and/or extensible markup language (XML) implemented interactive applications, as a service offering may be implemented, and may allow, e.g., but not limited to, interactive client to remote server device interaction in well known matters via various wellknown network protocols such as the internet protocol (IP) and the transmission control protocol (TCP), as well as any well known network stack implementing the various communications layers of the OSI model for standard communication between two or more computing devices. According to an exemplary embodiment, many exemplary commercial cloud service providers may be used to host an application, if not a separate server one may use a cloud based offering such as, e.g., but not limited to, Amazon, Rackspace, Microsoft and/or many others as will be apparent to those skilled in the art, offering such capabilities, or alternatively application service providers (ASPs), software as a service (SAAS) providers, etc.

FIG. 1C depicts an exemplary embodiment of an exemplary system 130 illustrating an exemplary distributed network environment, according to an exemplary embodiment. Diagram 130 of FIG. 1C illustrates an exemplary social network user devices 102a, 102b (collectively referred to as 102, e.g., a personal computer (PC), or smartphone, among other devices as illustrated in FIG. 1A above, etc.) by which a user may access a network 104 to gain access to other network resources, according to an exemplary embodiment. According to an exemplary embodiment, the user device 102 may communicate via network 104 to other user devices 102 via any of various communications applications such as, e.g., but not limited to, electronic mail systems, or a social network 110 as illustrated including social network service provider device 112 also coupled to network 104, according to an exemplary embodiment. According to various embodiments, the user devices 102 may also access an exemplary merit-based incentive system service provider 106, which as illustrated may include service provider user device 108b as may be used to handle, e.g., tracking of tasks, Karma points, points system value, etc., processing financial transactions to, e.g., but not limited to, a bank and/or credit card service, etc. As shown, the user devices 102 may access the exemplary to-do list system and incentive system service provider 106, via, e.g., but not limited to, a browser-based internet application, illustrated via web server 108a, which may perform such functions as providing load balancing and/or security, and/or a firewall for the service provider 106, as well as may then serve access to one or more application servers, such as, e.g., but not limited to, may include a database management system such as, e.g., but not limited to, a relational database, or other application software system, according to an exemplary embodiment. Further, as illustrated, other devices of users such as, e.g., but not limited to, application store devices, or other devices 116a, 116b (collectively 116), may be used to originally subscribe to the service provider's system, for app based embodiments, and may be downloaded onto the appropriate device, as discussed below, which when executed, may be used by an assigning user as illustrated in creating and assigning task items to a performing user's task list of tasks to be performed by the performing user using the exemplary system as disclosed to track completion of the tasks, track rewards earned, and/or redemption/fulfillment of rewards earned, according to various embodiments of the invention. For example, a parent (or other assignor) using an assigning user device 116 may use the exemplary system to create a list of tasks for the parent's child (or other assignee) to perform, in order to earn the child's allowance, or assignee's desired benefit, and the allowance/benefit may be redeemed in the form of Karma points (point system value), managed in an account tracked on the service provider's device, in one exemplary embodiment.

FIG. 1D depicts an exemplary embodiment of diagram 140 of an exemplary system illustrating an exemplary network environment. FIG. 1D illustrates an exemplary overview of an exemplary system as may be used in an exemplary environment according to various exemplary embodiments of the present invention. FIG. 1 depicts an exemplary embodiment of a high level system block diagram 140 that can be used to provide an exemplary system for providing a non-quantitative information search and response engine according to an exemplary embodiment of the present invention.

The high level system block diagram 140 of FIG. 1D may include, in an exemplary embodiment, users interacting with browsers on client devices 102a, or 102b (collectively 102), respectively. Browsers can be, e.g., but not limited to, application software programs executing on computer workstations or other computer processor based devices 102 (including mobile devices such as, e.g., but not limited to, communication devices, phones, smartphones, tablets, and/or computer tablets), which may be coupled via a network 104 (in wireline and/or wireless fashion) to other devices, as shown, in an exemplary embodiment. Workstations 102 can be coupled via a network 104 such as, e.g., but not limited to, an internet, and intranet, or another type of network. In an exemplary embodiment network 104 may include the global Internet. Network 104 may provide access for client devices 102 to gain access to, e.g., but not limited to, one or more application servers 110a, 110b (collectively 110), such as, e.g., but not limited to, a database management system (DBMS). Although a client server topology is discussed any of various other well-known types of communications topologies may also be used such as, e.g., but not limited to, point-to-point, peer-to-peer, cloud-based, software as a service (SAAS), browser-based, hierarchical, distributed, and/or centralized, etc. The application server 110 can manage one or more databases (collectively 112). In an exemplary embodiment, the application server 120 can access an exemplary database(s) 114 having a plurality of data records, where in an exemplary embodiment, each data record may have one or more fields, etc. It will be apparent to those skilled in the art, that each database 112, 114 can be part of a larger database, or could be broken into a plurality of separate subdatabases. In an exemplary embodiment of the present invention, search results can include a plurality of records obtained from the database 112, 114 that meet search criteria included in a search query. Network 104 may be coupled to any of various well known components such as, e.g., but not limited to, one or more load balancing devices or firewall devices 106a, 106b (collectively 106), web server(s) 108, application server(s) 110, routers, gateways, physical layer devices, data link layer devices, and/or network layer devices, etc.

As illustrated, web servers 108 and application servers 110 may be coupled to one another via one or more network(s) 104. Although network 104 is shown, in an exemplary embodiment, as being downstream of load balancing devices 106, it is also possible to have a network upstream of load balancing devices 104, coupling, e.g., but not limited to, application server(s) 110, web server(s) 108, and/or database(s) 112, 114, as well as other client or other server devices (not shown), local and/or remote from the depicted exemplary devices, etc. Exemplary client devices 102 are depicted downstream over an exemplary network(s) 104 from the server devices, but could easily be elsewhere in the network topology, e.g., inside, or outside a firewall. It is also important to note that network 104 is represented in cloud metaphor schematic, but various well known network devices including various well-known star-based, bus-based, or other well known network topologies may also be represented by exemplary network(s) 104.

A user interacting with a browser on workstation 102a can access the database 114a, in an exemplary embodiment by traversing several intervening networks using well known communications protocols such as, e.g., but not limited to, transmission control protocol/internet protocol (TCP/IP). Specifically, in an exemplary embodiment, the workstation 102a can be coupled via exemplary network(s) 104 including, e.g., but not limited to, a public and/or private network, and/or the global Internet to any of various exemplary website system(s), in this exemplary case, web server(s) 108a, 108b (collectively 108), which may include any of various hosting systems such as, e.g., but not limited to, a domain system, a domain name server (DNS), a domain controller system, etc. Website or webserver system 108 in an exemplary embodiment can be, e.g., but not limited to, the Dijadoo To-do list Merit-based Incentive and/or Rewards System Service Provider website available from Didjadoo (didjadoo.com) of West Simsbury, Conn. USA. The website system 110 can include, in an exemplary embodiment, an exemplary firewall 106 coupled to, or in addition to, or integrated with, a load balancer 106a, 106b (which could alternatively run on a general purpose computer such as, e.g., web server 108a, 108b, etc. Load balancer 106 can be coupled to an exemplary web server 108a, and 108b. Web servers 108a, 108b can be mesh coupled to one or more application servers 110a, 110b, via hardware and/or software system solutions, according to an exemplary embodiment, or via another network 104 (not shown). Each server 108, 110, may include, e.g., but not limited to, or be coupled to, one or more database(s) 112, 114. Web server(s) 108a, 108b in an exemplary embodiment, can perform load balancing functions by transferring user application requests/queries to one or more of the application servers 110a, 110b. Results of the exemplary requests and/or queries from database 114 can be transferred from application servers 110a, 110b through web servers 108a, 108b through the network 104 to workstation 104.

The portal application program and/or links to the portal, may be integrated and/or embedded into other well known collaborative, and/or social networking environments or applications such as, e.g., but not limited to, Facebook, LinkedIn, LotusLive, Microsoft Exchange/Sharepoint, GoogleTalk, GoogleVoice, Skype, Facetime, Google+, and/or video teleconferencing, Voxeo, SalesForce.com, CRM systems, etc., and/or other network environments, social media environments, communications environments, and/or collaborative environments.

Any illustration of exemplary fixed images, and/or exemplary arrangements of the exemplary portal is merely exemplary, but nonlimiting, as video means, audio means, and/or a combination of audio/video streams and/or other content may also be used to enable efficient user interaction, according to various exemplary embodiments.

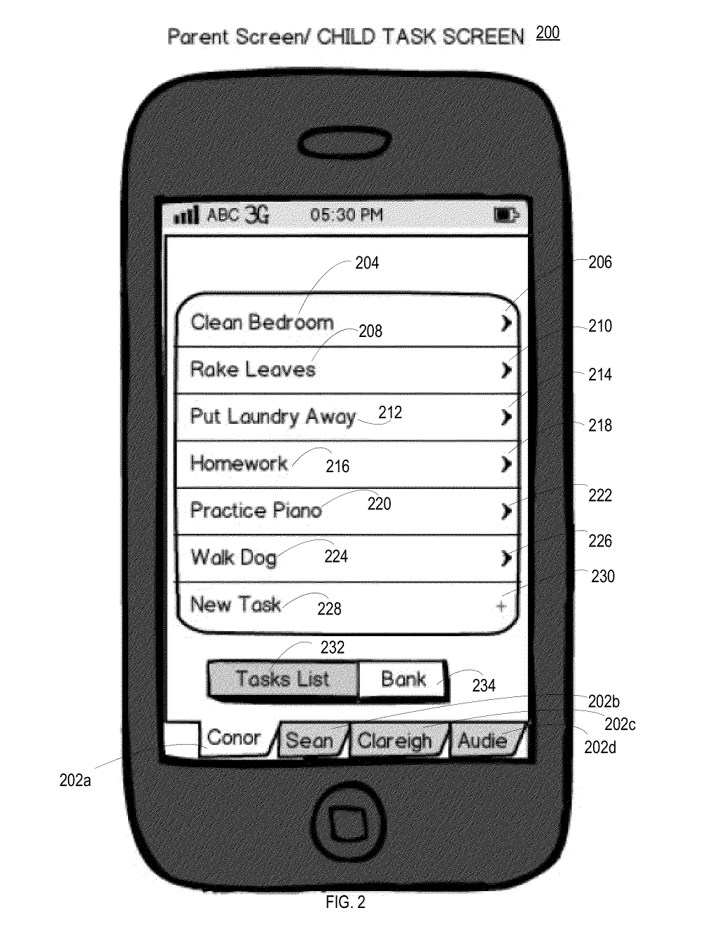

FIG. 2 depicts an exemplary embodiment of an exemplary screenshot of an exemplary user interface (UI) 200 illustrating an exemplary to-do list application program for managing and tracking an exemplary list of a plurality of tasks (e.g., previously assigned by an exemplary assigning user or assignor, e.g., but not limited to, a parent) to be performed by a performing user or assignee (e.g., but not limited to, a child, etc.), according to one exemplary embodiment.

FIG. 2 depicts an exemplary embodiment of a diagram 200 illustrating an exemplary user interface screenshot depicting an exemplary user interface of a performing user application, according to an exemplary embodiment. Various optional features for an exemplary application may be depicted, but need not necessarily be included in all embodiments. For example, diagram 200 may illustrate inclusion of an interactive user interface as may include one or more hyperlinks 202-210, illustrating an exemplary list of an exemplary one or more task items 202-210 as may have been previously assigned by an assigning user, to be performed by a performing user. The UI 200 may include various interface elements 202-332, including folder tabs 202a, 202b, 202c, and 202d (collectively 202), and task list button 232, and bank 234. An exemplary list of tasks for an exemplary user include tasks 204, 208, 212, 216, 220, 224, and 228. According to an exemplary embodiment, further details about each task list item may be accessed by user interface elements 206, 210, 214, 218, 222, 226, or 230, in an exemplary embodiment.

The application home interface page may include, in an exemplary embodiment, an exemplary image 214 of a given performing user, and/or an exemplary image 216 of a given assigning user, may be depicted to remind the user of users for which a task is being performed. The exemplary environment may accommodate an exemplary consistent user experience across an exemplary multiple platforms, permitting a user to access the to-do-list application on a handheld, and/or smartphone device, and/or via a browser-based Internet terminal, and/or via an applet based, and/or cloudbased and/or application service provider (ASP) based solution, and/or standalone computer applet based system.

According to one exemplary embodiment, a portal application program and/or links to the portal, may be integrated into and/or embedded other well known collaborative environments and/or social media applications such as, e.g., but not limited to, LotusLive, Microsoft Exchange/Sharepoint, GoogleTalk, GoogleVoice, Skype, Facetime, Google+, Facebook, and/or video teleconferencing, Voxeo, SalesForce.com, CRM systems, etc., and/or other network environments, social media environments, communications environments, and/or collaborative environments. Thus, the illustration of exemplary fixed images, and/or exemplary arrangements of the exemplary portal is merely exemplary, but nonlimiting as video means, an audio and/or a video stream and/or other content may also be used to assign tasks and/or manage reviewing, tracking and completing performance of various tasks by the performing user, according to various exemplary embodiments.

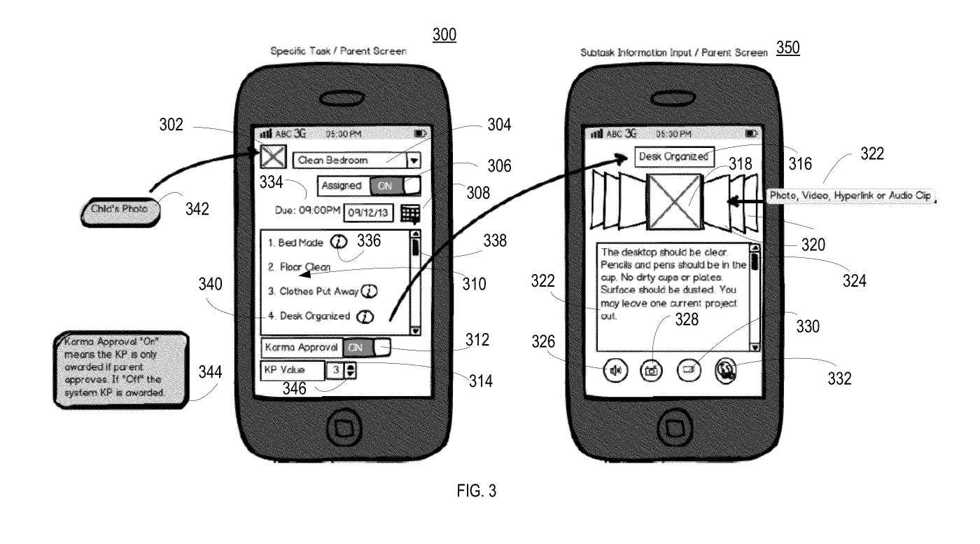

FIG. 3 depicts an exemplary embodiment of a diagram 300 illustrating an exemplary user interface screenshot for an exemplary embodiment of an application automating creation of an exemplary task list by exemplary assigning user, using an exemplary graphical user interface (GUI) application program as may be used to assign one or more tasks to the automated electronic to-do list to be performed by the performing user.

FIG. 3 depicts an exemplary embodiment of an exemplary screenshot of an exemplary user interface (UI) 300, 350, illustrating an exemplary application program of an exemplary assigning user, by which the assigning user or assignor (e.g., but not limited to, a parent) may assign one or more tasks to a task list to be performed by the performing user or assignee (e.g., but not limited to, a child, etc.). The UI 300 may include various interface elements 302-314, 334, 338, and 346. The UI 350 may include various interface elements 316-332.

FIG. 3 screenshot 300 is explained further according to an exemplary embodiment, where, upon selection of user interface element 204 or 206 of FIG. 2, an exemplary display may appear such as shown in exemplary screenshot 300 including, for example, but not limited to, a date due element 334, with calendar selection element 308, an exemplary assignment status button 306, an exemplary photo of an associated assignee for the task, image 302, a task description 304, instruction list 310 including exemplary instructions 340, and elements to obtain further information 336, and scroll bar element 338, with operation via an exemplary touchscreen by finger, pointing device, and/or stylus, as will be apparent to those skilled in the art. An exemplary and nonlimiting, points value system activation status button 312, which according to an exemplary embodiment as illustrated in comment 344 may be used to award point in exemplary situation where the assignor provides approval, and associated exemplary points value for the given task 314 may be selected and increased or decreased by user element 346.

FIG. 3 screenshot 350 is explained further according to an exemplary embodiment, where, upon selection of user interface element 336 associated with task list 304, list item 340, “4. Desk Organized”, the screenshot 350 may be displayed providing further exemplary instruction details for instruction step title 316 including, e.g., but not limited to, content 322, which may include any of various well known forms of content, including various digital content, audio, visual, video, image, picture (e.g., photo), text, hypertext, hyperlinked text, etc. Various available content may be displayed in a content gallery or listing, as shown in an exemplary horizontal range of elements, and an individual piece of content may be selected such as by clicking on icon 318, or by scrolling to the right (e.g., using elements 320) or left using a touchscreen page advance exemplary gesture, or the like, as will be apparent to those skilled in the relevant art. Exemplary text instructions 322 are shown along with scroll bar element 324. Various additional interface elements may be provided to, e.g., capture content, display content, etc., such as, e.g., but not limited to, sound capture element 326, image capture element 328, and other elements 330 and 332, such as e.g., but not limited to, battery, flash, and/or any of various other useful functions as displayed, and described and claimed herein.

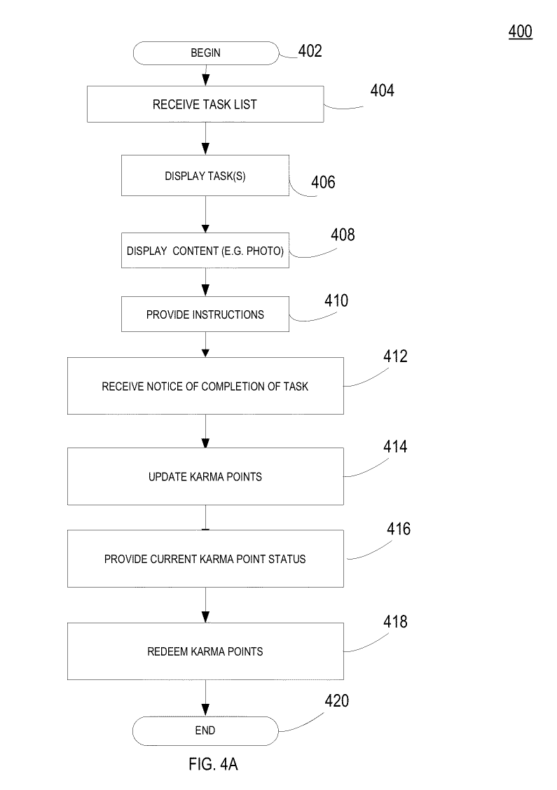

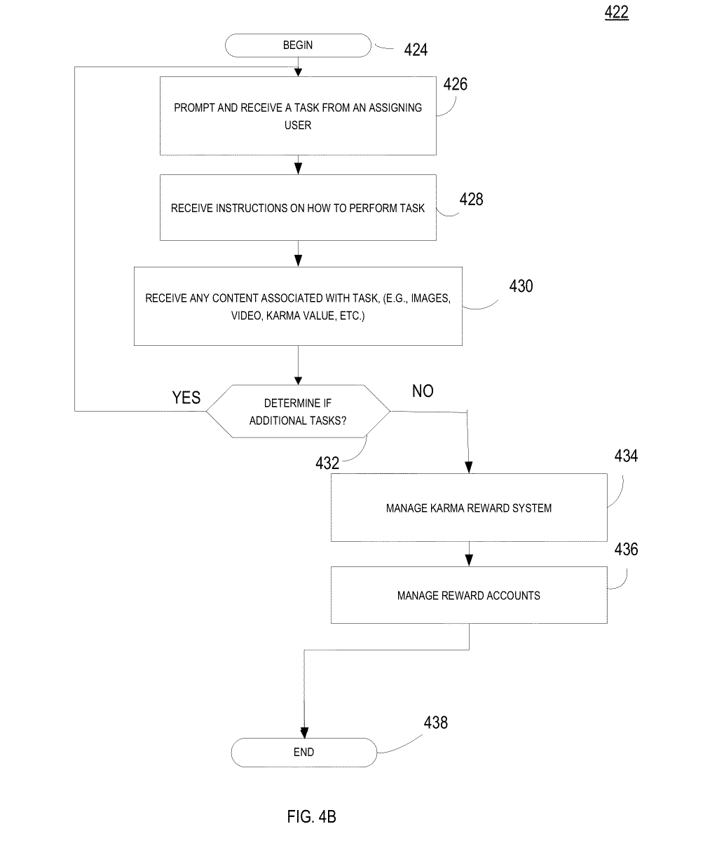

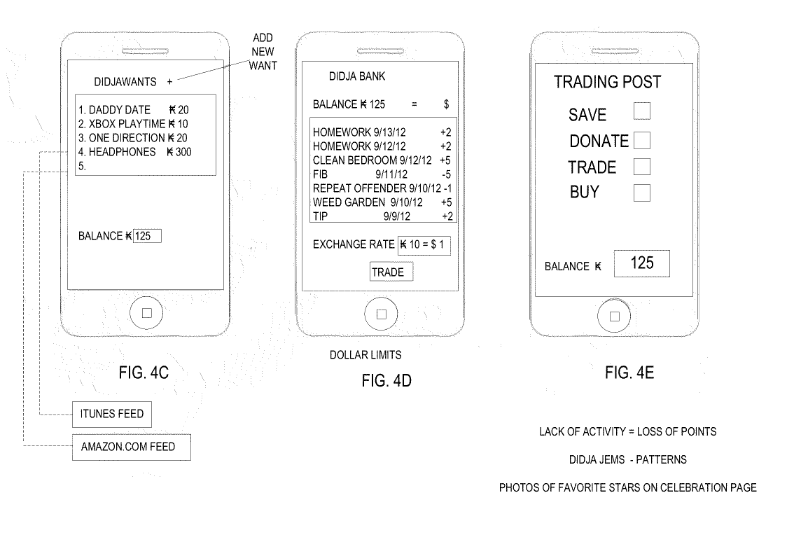

FIG. 4A depicts an exemplary flow diagram 400, according to an exemplary embodiment illustrating an exemplary process of managing performance of one or more tasks, assigned by an assigning user to a performing user, to be performed by the performing user.

Flow diagram 400 may begin as shown, in an exemplary embodiment with 402, and may continue immediately with 404, in an exemplary embodiment.

In 404, a device of a performing user, such as, e.g., but not limited to, a child, according to one exemplary embodiment, may receive a task list. The computing device may accept the task list and display the list to the performing user for review and completion of actions. From 404, the flow diagram 400 may continue with 406, in an exemplary embodiment.

In 406, the method may display one or more tasks to be completed by the performing user, i.e., the child. Then flow diagram 400 may continue with 408, in an exemplary embodiment.

In 408, the method may display content including, e.g., but not limited to, content captured relating to the tasks assigned. From this, then flow diagram 400 may continue with 410, in an exemplary embodiment.

In 410, the method may provide instructions to the child instructing how to complete the task item, and, then flow diagram 400 may continue with 412, in an exemplary embodiment.

According to an exemplary embodiment, the computing device may next, beginning with exemplary elements 412-418 receive various exemplary Karma point related transactions.

In 412, the computing device may receive an indication from the performing user, of completion of the task. From 412, flow diagram 400 may continue with 414, in an exemplary embodiment.

In 414, the computing device may receive and update (and/or store) a value for the Karma points earned from completion of the task, by the assigning the currency value, in association with an identifier for the given performing user. From 414, flow diagram 400 may continue with 416, in an exemplary embodiment.

In 416, the computing device may provide and/or display (and/or store) the current Karma point status for a given performing user. From 416, flow diagram 400 may continue with 418.

In 418, the computing device may receive a request to redeem Karma points (and/or store), and may process the request. From 418, flow diagram 400 may continue with 420 and may immediately end, according to one exemplary embodiment.

FIG. 4B depicts an exemplary flow diagram 422, according to an exemplary embodiment illustrating an exemplary process of receiving assignment of task elements to a task list for completion by a performing user as described above in FIG. 4A for a first customer user, and for initializing and creating the task list, according to an exemplary embodiment.

Flow diagram 422 may begin as shown with 424, and may continue immediately with 426, in an exemplary embodiment.

In 426 a computing device may prompt and receive in response, a task from an assigning user, to assigning a task for a performing user, created by the process 400 described with reference to FIG. 4A above. According to an exemplary embodiment, the task list generator may be used by an assigning user to generate a thread. From 426, flow diagram 422 may continue with 428.

In 428, the computing device may receive (and/or store) instructions on how to perform the task. From 428, flow diagram 422 may continue with 430, in an exemplary embodiment.

In 430, the computing device may initialize a task, and may receive and instructions on how to perform the task. From 430, flow diagram 430 may continue with 432.

In 432, it may be determined by the computing device whether there are additional tasks to perform. From 432, flow diagram 422 may continue with 426 in the case of additional, and if there are no more tasks to be performed, then flow diagram 422 may continue with 434.

In 434, the computing device may manage the karma reward system. From 434, flow diagram 422 may continue with 436.

In 436, the computing device may manage reward accounts. From 436, in an exemplary embodiment, flow diagram 422 may continue with 438, and flow diagram 422 may continue immediately by ending with 438, in an exemplary embodiment.

FIG. 4C depicts an exemplary screenshot of an exemplary user interface (UI) illustrating an exemplary application program for among other things displaying an exemplary current balance of points for an exemplary points value system; an exemplary interface for adding exemplary negative point value and/or exemplary positive point value to an exemplary base value, to obtain an exemplary final point value; and exemplary functionality to convert points system value into, e.g., exemplary monetary value, etc.

Various other exemplary functionality may included in various embodiments, according to an exemplary embodiment, as supported by the examples provided herein in outlined exemplary form, as well as in the below exemplary claims, as well as in the Figures, and appendices.

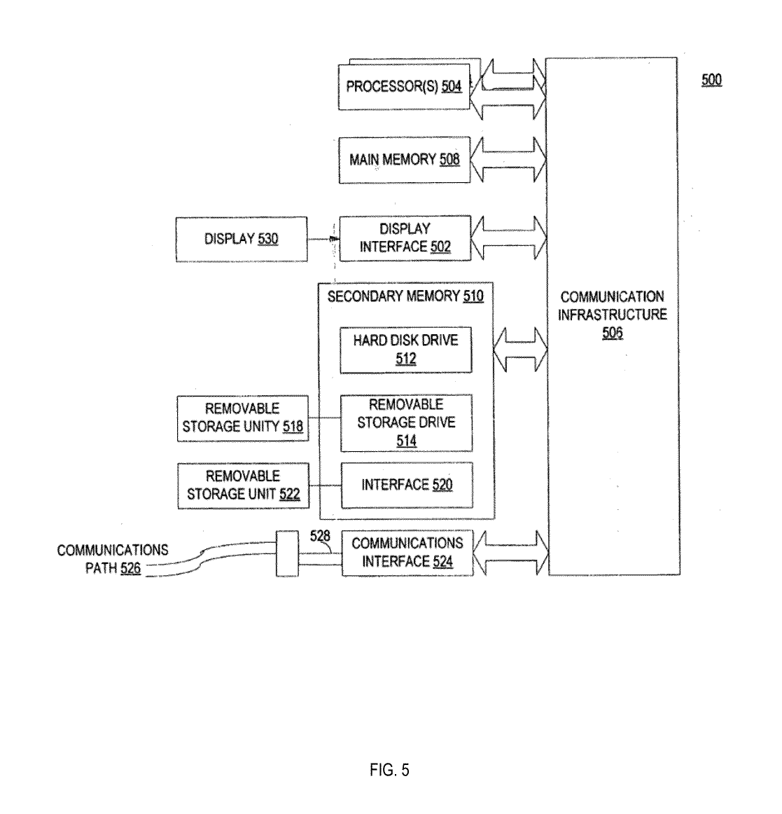

FIG. 5 depicts an exemplary diagram 500 illustrating an exemplary computer/communications device hardware architecture as may be used in various components of exemplary embodiments of the present invention. FIG. 5 depicts an exemplary diagram 500 illustrating an exemplary computer/communications device hardware architecture as may be used in various components of exemplary embodiments of the present invention. FIG. 5 depicts an exemplary view 500 of an exemplary computer system 102, 104, 112 as may be used in implementing an exemplary embodiment of the present invention. FIG. 5 depicts an exemplary embodiment of a computer system that may be used in computing devices such as, e.g., but not limited to, user devices 102, 102a, 102b, promotions service provide device 108, 108a, 108b, and/or web server 108a and/or application server 108b, social network computing device(s) 112 of social network 110, vendor user devices 116, 116a, 116b and 114, network components 104, etc. according to an exemplary embodiment of the present invention. FIG. 5 depicts an exemplary embodiment of a computer system that may be used as client device 108, or a server device (not shown), etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 500 is shown in FIG. 5, depicting an exemplary embodiment of a block diagram of an exemplary computer system useful for implementing the present invention. Specifically, FIG. 5 illustrates an example computer 500, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/7/8 . . . , etc. available from MICROSOFT® Corporation of Redmond, Wash., U.S.A., SOLARIS® from SUN® Microsystems of Santa Clara, Calif., U.S.A, OS/2 from IBM® Corporation of Armonk, N.Y., U.S.A, Mac/OS, OS/X, iOS from APPLE® Corporation of Cupertino, Calif., U.S.A, etc, or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 500 is shown in FIG. 5. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, a tablet, a phone, a mobile phone, a cellular phone, a communications device, an iPod, an iPhone, a smartphone, an iPad, a tablet based device, a smart phone, an ANDROID OS device, an iOS device, a Symbian based device, a Windows 8 device, etc., may also be implemented using a computer such as that shown in FIG. 5.

The computer system 500 may include one or more processors, such as, e.g., but not limited to, processor(s) 504. The processor(s) 504 may be connected to a communication infrastructure 506 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 500 may include a display interface 502 that may forward, e.g., but not limited to, graphics, text, and other data, etc., from the communication infrastructure 506 (or from a frame buffer, etc., not shown) for display on the display unit 530.

The computer system 500 may also include, e.g., but may not be limited to, a main memory 508, random access memory (RAM), and a secondary memory 510, etc. The secondary memory 510 may include, for example, (but not limited to) a hard disk drive 512 and/or a removable storage drive 514, representing a floppy diskette drive, a magnetic tape drive, an optical disk drive, a compact disk drive CD-ROM, etc. The removable storage drive 514 may, e.g., but not limited to, read from and/or write to a removable storage unit 518 in a well known manner. Removable storage unit 518, also called a program storage device or a computer program product, may represent, e.g., but not limited to, a floppy disk, magnetic tape, optical disk, compact disk, etc. which may be read from and written to by removable storage drive 514. As will be appreciated, the removable storage unit 518 may include a computer usable storage medium having stored therein computer software and/or data.

In alternative exemplary embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 522 and interfaces 520, which may allow software and data to be transferred from the removable storage unit 522 to computer system 500.

Computer 500 may also include an input device such as, e.g., (but not limited to) a mouse or other pointing device such as a digitizer, and a keyboard or other data entry device (none of which are labeled).

Computer 500 may also include output devices, such as, e.g., (but not limited to) display 530, and display interface 502. Computer 500 may include input/output (I/O) devices such as, e.g., (but not limited to) communications interface 524, cable 528 and communications path 526, etc. These devices may include, e.g., but not limited to, a network interface card, and modems (neither are labeled). Communications interface 524 may allow software and data to be transferred between computer system 500 and external devices. Examples of communications interface 524 may include, e.g., but may not be limited to, a modem, a network interface (such as, e.g., an Ethernet card), a communications port, a Personal Computer Memory Card International Association (PCMCIA) slot, PC Card, SDRAM, universal serial bus (USB), solid state device (SSD), and card, etc. Software and data transferred via communications interface 524 may be in the form of signals 528 which may be electronic, electromagnetic, optical or other signals capable of being received by communications interface 524. These signals 528 may be provided to communications interface 524 via, e.g., but not limited to, a communications path 526 (e.g., but not limited to, a channel). This channel 526 may carry signals 528, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to media such as, e.g., but not limited to removable storage drive 514, a hard disk installed in hard disk drive 512, and signals 528, etc. These computer program products may provide software to computer system 500. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct or indirect physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), may include object oriented computer programs, and may be stored in main memory 508 and/or the secondary memory 510 and/or removable storage units 514, also called computer program products. Such computer programs, when executed, may enable the computer system 500 to perform the features of the present invention as discussed herein. In particular, the computer programs, when executed, may enable the processor 504 to provide a method to resolve conflicts during data synchronization according to an exemplary embodiment of the present invention. Accordingly, such computer programs may represent controllers of the computer system 500.

In another exemplary embodiment, the invention may be directed to a computer program product comprising a computer readable medium having control logic (computer software) stored therein. The control logic, when executed by the processor 504, may cause the processor 504 to perform the functions of the invention as described herein. In another exemplary embodiment where the invention may be implemented using software, the software may be stored in a computer program product and loaded into computer system 500 using, e.g., but not limited to, removable storage drive 514, hard drive 512 or communications interface 524, etc. The control logic (software), when executed by the processor 504, may cause the processor 504 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

Exemplary embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

The exemplary embodiment of the present invention makes reference to wired, or wireless networks. Wired networks include any of a wide variety of well known means for coupling voice and data communications devices together. A brief discussion of various exemplary wireless network technologies that may be used to implement the embodiments of the present invention now are discussed. The examples are non-limited. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11 compliant wireless local area network (LAN), 802.16-compliant wide area network (WAN), and ultrawideband (UWB), etc.

Bluetooth is an emerging wireless technology promising to unify several wireless technologies for use in low power radio frequency (RF) networks.

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d or g, such as, e.g., but not limited to, IEEE std. 802.11a, b, d and g, (including, e.g., but not limited to IEEE 802.11g-2003, etc.), etc.

### Exemplary Functional Specification Outline

According to one exemplary, but non-limiting embodiment, an exemplary Didjadoo (West Simsbury, Conn. USA) exemplary functional specification, functionality outline may include, e.g., but is not limited to, the following example functions, in the exemplary embodiment (wherein for ease of reading the functional description is made from a user point of view, but should be read to enable a computer implemented system embodying such functionality and enabling user interaction via an exemplary graphical user interface executed on a computer including one or more computer processor(s), and one or more memory and/or storage device(s), and/or one or more other input device(s), and/or output device(s):
1. Administration
   a. Create Initial Account
      i. Sign Up (web)
         1. Create User Name and Admin Password
      ii. Sign Up (mobile)
   b. Create Parents
      i. Username, Name, a.k.a “Mom”, “Dad”, “X”
      ii. Password or PIN
      iii. Email address
   c. Create Children
      i. Name, Age, Sex
      ii. Email address
      iii. Choose Motif
   d. Create DidjaBank (Karma tallying-reward assignment & tracking systems)
      i. Each Child has an account in their name for credit/debit of Karma Points
      ii. The DidjaBank has unique accounts (by child) that continuously tally KP. KP may be awarded or deducted based on outcomes of Tasks, Repeat Offenders, Tips, Trades and Gifts. KP may grow through compounding interest if enabled by parent. No Monetary Spending can occur directly from the DidjaBank.
      iii. Allow Negative Balance (Y/N)
         1. If set to “Y” then the KP tally can be negative
         a. Apply Interest Rate for KP Negative Balance (Y/N) this acts like interest on a consumer credit card.
         b. Negative balance only applies to DidjaBank accounts; never on Converted monetary authorization.
         2. If set to “N” then no deductions can occur to the KP balance once it reaches zero. Once the tally is >0, KP may be deducted.
      iv. Transactions that may occur within the DidjaBank are Gift, Trade, Exchange and Conversion.
         1. Before any DidjaBank Transactions can be made, the child must review a statement about the compounding and interest: “Your current balance is ______. If you leave the balance in savings for two more weeks, the balance will be ______.”
         2. Set Interest Rate—teaching consumer finance, delaying gratification
         a. An interest rate allows KP to grow prior to conversion to monetary account or nonmonetary use. Teaches patience and the positive power of compounding.
         3. Gift to another DidjaBank account within the same family
         a. A gift of KP will move the desired amount of KP to another member.
         4. Trade with another DidjaBank account in the same family
         a. A Trade occurs when two members within the same family agree to exchange a physical item or activity or duty, for KP.
         b. The Trade is executed by the person contributing KP. The amount is held in “escrow” until a parent approves the trade.
         5. Exchange for an item off the child's Wish List
         a. The Wish List contains physical items that the child and parent have agreed are valid awards.
         b. The Wish List items each have a KP value as determined by the parent.
         6. Conversion—only if Parent enables
         a. A Conversion is the calculation of equivalent currency based on the Exchange Rate defined by the parent.
         b. A conversion reduces the KP while increasing the currency available for authorized monetary exchange per rules below. No money is “banked”, only the preauthorization of a monetary equivalent to be used in an approved monetary account based on the rules approved within that account.
         c. A child chooses when to convert KP to dollars by pressing the Convert button.
         d. Periodicity: A parent may define the minimum periodicity to convert such as to only allow conversion once per week, once per month or continuous. This delay, allows the DidjaBank balance to be subject to the effects of interest and deductions prior to being “made safe” by conversion to the monetary account.
         e. Minimum Balance: Setting restricts conversion until a minimum balance of KP is achieved.
         f. % by Category: A parent may restrict the % conversion by category.
         i. Savings
         ii. Gifting
         iii. Charity
         iv. Online (DidjaPartner)
         v. Cash (Parent Teller Machine)
         g. Currency in a monetary account may be converted back to KP at the exchange rate (or the parent may define a unique reverse exchange rate)
      v. Set Karma Point-to-Currency Exchange Rate
         1. Define an exchange rate (KP:$ ratio)
         2. This rate is defined by the parent and can be changed at anytime.
      vi. Setup Monetary Spending Account(s)
         1. A DidjaBank account may be tied to a Controlled Account or Non-Controlled Account (i.e. PayPal)
         2. A Non-Controlled account is a pre-paid card or online spending mechanism with no additional controls.
         3. A Controlled Account has limits set up by the parent and the DidjaPartner to restrict certain types of transactions e.g. age inappropriate material.
         4. Create Controlled Account—(monetary spending account with rules)
         a. A Controlled Account is linked to a “PayPal” type account but with restrictions as set by the account owner to control the benefactor's purchase ability.
         b. A controlled account is linked to a parents checking or credit card account and is governed by the vendor (i.e. PayPal)
         5. Search DidjaPartners
         a. A DijaPartner is an online merchant or other entity with an online commercial presence that has an affiliation with Didjadoo.
         b. Tie Account to DidjaPartner
         i. By child
         ii. Associate the PayPal Control Number
         1. This links the shopping cart to the Controlled Account and runs rules for restrictions.
         6. Rules for Monetary Accounts
         a. Max Purchase Allowed
         i. Monetary limit on the total single purchase allowed on a DidjaPartner Site
         b. Age Limits
         i. Even though the child's age is entered, a parent may choose to customize the age appropriate categories. E.g. A video game rating is T (teen) but the parent authorizes a 12-year old to purchase on a DidjaPartner site.
         c. Require Parent Final Approval (Y/N)
         i. Allow parents to have a final say before purchase.
         7. Set email balance updates/warnings
      vii. DidjaPartner Access—A DidjaPartner is an online merchant or non-profit that has agreed to certain rules and restrictions as determined by Didjadoo and or the parents to govern the level of access a DidjaPartner has to the child. The intent is for the child to gain a benefit from the DidjaPartner (e.g. better deals) as well as the DidjaPartner benefiting from the child (e.g. access to a new market)
         1. Allow DidjaPartners access to Monetary Wish List
         a. The Monetary Wish List is a list of specific items available from Internet Retailers. The items may be found on any site including but not limited to a DidjaPartners site.
         b. If access is allowed, a DidjaPartner can view the entire list, including where a particular item was sourced for the list.
         c. With access, a Partner gains insight into what a “monetized” child wants.
         2. Allow DidjaPartners access to send deals
         a. Setting allows parent to approve or disallow access by DidjaPartners, to potentially access potential spend and wishlist, to send coupons, offers, etc. to the child. This setting can be used whether a Partner has access to the Wish List or not.
         b. Any DidjaPartner has access to any deals sent. This will enable bidding and improve the child's deal.
         3. Allow DidjaPartners to see available balance
         a. Setting allows parent to approve or disallow access by the DidjaPartner to see child's converted balances (in spend categories)
         b. This setting will enable a Partner to market to a child through targeted deals. A partner could discount the items with a coupon to secure the balance.
2. Create Tasks
   a. Browse System Suggested Tasks
      i. Using the community, browse, view and choose to import tasks created by Didjadoo community
         1. Modify any attribute
   b. Create Tasks—creation of a tangible reward system, and instructional steps
      i. Scratch Tasks (One screen with pull down, auto suggestions, open space for text and file choice buttons)
         1. Task Name
         a. The name identifying the task. This will show in the Task Queue
         2. Task Category
         a. This is optional but is used to group similar tasks such as “Homework, Cleaning, Yard Work, etc.
         3. Deadline
         a. This is the time by which the parent expects the task to be submitted. The deadline is used to calculate modifications to the KP Base as well as to calculate the warnings and notifications.
         4. Assign KP Base—(e.g., value of completed task with no modifications, 10%, or if completed early, they can get a bonus, can be modified by kid's performance, and can be modified by parent as well)
         a. The parent assigns an initial KP Base from which modifications may occur based on timeliness and quality.
         5. Priority
         a. This is an optional setting that allows the parent to assign a generic priority (high, medium, low) or a unique ranking (“Do this before that”)
         6. Recurrence
         a. For tasks that reoccur (like taking the task out once a week), the parent may add a recurrence.
         7. Instructions
         a. Create Instructional Media (“IM”) consisting of video, pic, doc/text, audio file, etc.
         b. Import IM from previously created files or from Didjadoo Community.
         c. Is opening of IM required? If YES, then the child is not allowed to submit task to Complete/Incomplete unless IM files are opened. If NO then child may set task to Submitted Complete/Incomplete
         8. Verification (Parent Assessment)
         a. Verification toggle (YES/NO)
         b. If set to YES, the Child is required to provide verification media (VM) on job completion/quality. This VM may be photo(s), voice, text or video.
         i. If set to YES, and required VM is not uploaded, the child will not be able to submit for Complete.
         c. If set to NO, then no VM is required (though it can be provided voluntarily) to move the task to Submitted.
      ii. Wizard Tasks
         1. Interview asks same questions as Scratch Task with suggestions.
         3. Assign Tasks to Child
   a. “Is this a shared task?” CHECK BOX slider, default to “NO”.
      i. A Shared Task is one that is divided among two or more Children.
      ii. If Slider is set to YES, then allow multiple children to be chosen.
      iii. Assign team leader. This designation places one of the children overall responsible for the task's completion.
   b. Choose the Child(ren) to whom the task is assigned.
   c. The Assigned Child's Status page is shown with all currently assigned tasks and associated status.
   d. Parent “Sends Task”
   e. Child(ren) receive tasks on their device
   f. Parent's device shows “Received” indication on the child's queue.
4. Track Status
   a. The Parent's device shows each child's task queue with status (Sent, Received, Rejected, In Progress, Incomplete, Complete)
   b. Sent: Parent has sent the task to child
   c. Received: The task has successfully been registered on the child's device and in queue.
   d. Rejected: The child has Rejected the task. The rejection is only registered if the child provides a reason. A task may only be rejected one time. A rejected task is sent back to the Parent's device where it must be reassigned or canceled. A rejected task that is reassigned may be sent to another child or back to the original child. The tasks details may be adjusted or remain the same.
   e. In Progress: A task that is “In Progress”, means the child has opened the task details.
   f. Submitted-Completed: The child has uploaded any VM and task has been sent to parents' queue and awaits Assessment.
   g. Submitted-Incomplete: The task is not completed and the child can/will not advance the task to Complete. An Incomplete Task requires VM to provide the parent context as to why task was not completed.
   h. Complete: A task is set to Complete under two conditions
      i. If Parental Assessment is required, a task may only be set to Complete by the parent. The parent may provide Assessment Media AM (photo, video, voice, text) along with awarding/modifying KP. A parent may also re-assign the task to the child, which resets the status to Sent.)
      ii. If Parental Assessment is not required, the task automatically is set to Complete and the corresponding KP is awarded to the Child's account.
   i. Incomplete: Any task that is submitted as Incomplete sits in the parents' queue for review.
      i. If no review is made, the task remains in queue until it's deleted by the parent.
      ii. Upon review, the parent may reassign, close or accept.
      iii. If the Incomplete is reassigned, the task reenters the normal task queue.
      iv. If the Incomplete is closed, no further action is taken and the task drops from all queues.
      v. If the Incomplete is accepted, the parent may modify KP or allow full KP to be awarded.
      vi. Incomplete tasks are counted towards stats.
   j. Award: A task that is in Complete or Incomplete status may be assigned KP. If KP is awarded either by the parent or by the system, the status is set to Award.
   k. Closed: A task is Incomplete and no award is made.
5. Assessment
   a. Assessment is required if at the time of task creation, the parent has chosen “Assessment” slider to YES.
   b. If YES, the parent may choose one or more Assessment Media (AM) and/or Verification Media (VM) be provided by the child—capturing proof.
      i. Photo—Parent provides text captions for each picture they desire. The child would then take photos and assign the associated caption to each.
      ii. Video—The parent may indicate via text or voice the content they wish to see via a short video clip.
      iii. Audio: The parent may require the child to submit a short audio clip.
      iv. Text: The parent may wish the child to provide context via simple written text.
      v. File: The parent may require that the child submit a file (e.g. scan of a homework assignment)
   c. If, NO, than no AM is required, though a child may submit their choice of AM voluntarily. A NO, means that the Submitted-Completed task changes status automatically to Completed and that the system KP is awarded to the child's account.
6. Rewards—Credit/Debit
   a. A task, will have a system KP associated with it. The system KP will be one of the following:
      i. Base KP: This is the KP that the parent assigned when creating or assigning the task.
      ii. System Modified KP: This is equal to the Base KP, modified by the system for such criteria as time (early, late)
      iii. Parent Modified: Both Base KP and System Modified KP can be overwritten by the parent if Assessment is set to YES.
      iv. The resulting KP after all modifications is called the Award KP
7. Repeat Offenders (RO)—a specialized task that can be recalled at any time (e.g., wet towel on the floor, click on it, take a picture, automatically assessed a negative 3 KP)
   a. RO's are recurring bad habits/issues/behaviors a parent wants a child to correct such as leaving a wet towel on the floor. A RO can be set up as a Task and is called up on a unique screen to capture an instance of an RO.
   b. An RO will have a default Base KP (negative) associated with it.
   c. An RO goes immediately to Completed Status and shows on the child's queue as an RO. The child has a set amount of time (determined by the parent in the RO setup) to respond to the RO. A response could be “It wasn't me” This is called a Challenge.
      i. An RO that is challenged can be accepted/closed, rejected/closed or reassigned to another child.
      ii. An Accepted RO Challenge closes and no KP award (deduct) is made.
      iii. A Rejected RO Challenge closes and the KP deduct is made to the child's account.
      iv. A Challenged RO that is reassigned makes no change to the original child's KP.
      v. An RO whose system time has expired, moves to Award status and the associated KP is deducted from the child's account.
      vi. RO stats are archived and reportable.
   d. Once the Award KP is determined, the status is set to Award and the Award KP is deposited to the associated child's DidjiBank Account
8. Tips (e.g., opposite of a repeat offender, an attaboy)
   a. A parent may Tip a child for completing an unassigned task or for any other reason they choose. A tip is meant to reward initiative, acts of kindness or to recognize merit.
   b. The Tip screen is a quick access that allows the parent to choose the child, document the tip with text, voice or other media.
   c. The tip screen allows the parent to add KP of any amount to the child's DidjaBank balance.
   d. A notification is sent to the child when a tip occurs.

According to one exemplary embodiment, a child may be hired as a pet sitter for a week while a neighbor is on vacation. The neighbor (an exemplary assignor) can log on and assign specific tasks (e.g., but not limited to, feeding, walking, clean up, and/or meds, etc.) to an exemplary assignee with exemplary task fields such as, e.g., but not limited to, instructions, exemplary deadlines, exemplary periodicity, points (and/or cash) and/or emergency contact info (i.e., e.g., but not limited to, vet phone number, owner's vacation hotel number, etc). See QR codes, and/or other sensed information such as, e.g., but not limited to, MEMS sensor data, location sensing data, bar code, QR Code, RFID tag, sensor data, etc. below, as an exemplary way of capturing actively and/or passively, an indication of initiation and/or completion of a given task, etc.

According to another exemplary embodiment, an exemplary system may include features including enabling user interactive selectability of prioritization of tasks to be accomplished such that an assignor can designate one task to be done before another, for example, or provide a measure of relative importance and/or higher value ranking, etc.

According to another exemplary embodiment, an exemplary system may include features including a task that is accomplished before a deadline (based on time stamp) would be modified with bonus Karma and if completed late would reduce the base Karma.

According to another exemplary embodiment, an exemplary system may include features including both the “how” and the “how ell” assessment (e.g., proof of accomplishment (initiation and/or completion), and/or assignors assessment of the task, etc.).

According to another exemplary embodiment, an exemplary system may include features including providing a system that may enable interacting with or receiving codes (e.g., bar code scan, QR code, a multiple dimension barcode, a scan, image, recognized sound, MEMS sensor data, radio frequency identifier (RFID) tag, and/or other indications associated with a task and/or its completion and/or initiation. Exemplary QR codes (and the ability to print QR codes) to Didjadoo, may be provided including, e.g., but not limited to, an exemplary assignor may add an exemplary QR code scan requirement to “brush teeth.” The exemplary code may be created within Didjadoo and the assignor may, e.g., but not limited to, print the exemplary code on a label which may be affixed in the vicinity to the exemplary assignee's sink (and/or ordered and/or provided from an exemplary Didjadoo and/or other store which may, e.g., but not limited to, sending an exemplary laminated version with an exemplary adhesive back). When the exemplary assignee may brush the assignee's teeth, the assignee have to scan the associated QR code. According to another exemplary embodiment, a feature may capture the time, task an interesting timer (two minutes with cool music) and location. Maybe it kicks off a recording by the smart phone, a sample recording of which may be available for review, auditing (the rest of the videos may “dumped” but the assignee doesn't know which ones are available for audit!). Additional examples may include providing for placement of QR codes on garbage and recycling receptacles. The assignor may create exemplary codes for each location in vicinity of where task is to be performed, (e.g., a receptacle). The task may, according to an exemplary may be kicked off, initiated, or completed, by assignee and/or date/time, etc. The assignee may scan the first receptacle which may kick off, initiate, or mark complete, etc., the exemplary task details, points available, instructions and/or list of other receptacles needing service. Another example (see pet sitter above) may included when an exemplary assignee may be given a task by an exemplary outside and/or third party to do an exemplary task. An exemplary QR code or other code or sensor indication may be, or could be affixed by an exemplary 3rd party to a given device and/or apparatus to ensure that the exemplary assignee is at a house within the prescribed time frame. Exemplary pictures could be required to show feeding. Exemplary location based sensing, triangulating, and/or global positioning system (GPS) enabled location sensing could help determine, exemplary passive indications of task initiation and/or completion, e.g., an exemplary walking distance of dogs, etc.

According to another exemplary embodiment, an exemplary system may include features including an exemplary MEMs type sensor technology according to one exemplary embodiment. An exemplary embodiment may include exemplary sensor integration with Didjadoo enabling passive detection of task initiation, progress, and/or completion, etc. According to an exemplary embodiment, exemplary commercial service systems may show that requiring an exemplary technician to self report (e.g., perform data entry) often may mean that the technician may be more apt to not use, or may be found to be ignoring the system. Data collected may suffer if exemplary systems require active participation (and techs wanted to fix stuff, not do data entry). According to one exemplary embodiment, the things associated with a task, and/or tasks that the assignee may have including, e.g., but not limited to, working on an exemplary technology to report exemplary tasks and/or activity (e.g., passive collection, etc.) then much more data may be collected. According to an exemplary embodiment, if the dog bowl or the garbage can had a MEMs type sensor. Exemplary near field technology may enable exemplary connection with the smart device (e.g., iPhone, Android, MSFT OS, etc.) to connect which assignee (e.g., child and/or employee or other assignee, etc.)) may have performed the task (e.g., an exemplary accelerometer may shows the exemplary emptying of the exemplary can or the refill of water for dogs). Another exemplary features may be less than an exemplary improvement that the MEMs may tell the assignee(s) that a task is available based on the condition, e.g. the trash is full (based on weight), etc. The exemplary task may go to an exemplary queue that may be visible to, e.g., all possible assignees with an exemplary associated point value, etc., according to an exemplary embodiment.

The exemplary first assignee to complete the task may get the points, according to one exemplary embodiment.

According to another exemplary embodiment, an exemplary system may include features including enabling and/or facilitating communication in and amongst a community of “Didjadooers” that can share their tasks, how-to media training, and/or task initiation and/or completion, exemplary point systems and/or other ideas. We have an exemplary third party access, which according to an exemplary docketed; including an exemplary community access. According to one exemplary embodiment, features to allow exemplary community communication and/or social media discussions, may be provided, whereby an assignor may share any and/or all, etc., aspects of their Didjadoo profile to include an exemplary task, exemplary how-to media (videos, task descriptions, Karma:$ ratios, repeat offenders, etc.). According to one exemplary embodiment, exemplary fellow Didjadooers may rate the profiles of others so that people would know where to get great ideas.

While various embodiments of the present invention have been described above, it should be understood that they have been presented by way of example only, and not limitation. Thus, the breadth and scope of the present invention should not be limited by any of the above described exemplary embodiments, but should instead be defined only in accordance with the following claims and their equivalents.

What is claimed is:

1. A computer-implemented method comprising:
receiving, by at least one computer processor, a plurality of tasks,
wherein each of said plurality of tasks is assigned by an assignor to be performed by an assignee; and
managing, by the at least one computer processor, a point system associated with completion of said plurality of tasks.

2. The method according to claim 1,
wherein the assignor comprises at least one of:
a guardian; a boss, a neighbor, an employer, a partner, a provider, a vendor, a merchant, an advertiser, a third party, or a parent, and
wherein the assignee comprises at least one of:
a dependent; an employee; or a child.

3. The method according to claim 1, wherein said receiving said plurality of said tasks comprises at least one of:
receiving, by the at least one computer processor, a numeric value associated with task; or
receiving, by the at least one computer processor, data about each task of said plurality of tasks.

4. The method according to claim 1, wherein said managing comprises at least one of:
maintaining, by the at least one computer processor, a point balance associated with each assignee;
receiving, by the at least one computer processor, at least one indication of an adjustment to said point balance comprising at least one of:
receiving, by the at least one computer processor, at least one point value adjustment associated with at least one assignee, upon completion of at least one task of said plurality of tasks; or
receiving, by the at least one computer processor, an adjustment to said point balance comprising at least one of:
at least one indication of at least one credit to the balance of at least one assignee; or
at least one indication of at least one debit to the balance of at least one assignee; or
storing, by the at least one computer processor, said point balance.

5. The method according to claim 1, further comprising:
receiving, by the at least one computer processor, a request to transfer at least a portion of points of said point system.

6. The method according to claim 5, wherein said receiving said request to transfer points comprises at least one of:
receiving, by the at least one computer processor, a request to exchange points for a wish list item;
receiving, by the at least one computer processor, a request to gift points by a first assignee to second assignee;
receiving, by the at least one computer processor, a request to gift points within a group or family;
receiving, by the at least one computer processor, a request to buy intragroup or intrafamily value goods or services;
receiving, by the at least one computer processor, a request to trade points within a group or family for a value; or
receiving, by the at least one computer processor, a request to convert at least a portion of said point system value to a monetary spend equivalent value comprising at least one of:
receiving, by the at least one computer processor, a request to convert at least a portion of said point system value into a gift card value;
receiving, by the at least one computer processor, a request to convert at least a portion of said point system value into a third party payer equivalent value; or
receiving, by the at least one computer processor, a request to convert at least a portion of said point system value into at least one of:
a prepaid online account value;
a prepaid account value;
a merchant account value;
a merchant account bank card value;
a merchant account debit card value; or
a merchant account charge or credit card value.

7. The method according to claim 5, wherein said receiving said request to transfer comprises:
receiving a request to transfer at least a portion of said point system value for at least one of:
an intragroup good or service; or
an intrafamily good or service.

8. The method according to claim 7, wherein said intragroup or said intrafamily goods or services comprise at least one of:
a chore;
a communication device;
a computing device;
a networked device;
a wireless network device;
a gaming device;
a time period or duration of use of a communication device;
a time period or duration of use of a computing device;
a time period or duration of use of a networked device;
a time period or duration of use of a wireless network device;
a time period or duration of use of a gaming device;
time period or duration with a toy;
a time period or duration of use of with a screen device;
a time period or duration of use of with a device;
a time period or duration of use of with a friend;
a time period or duration of use of with a parent;
a time period or duration of use of with an individual;
a time period or duration of use of with a group; or
a time period or duration of use of with a tool.

9. The method according to claim 1, further comprising:
receiving, by the at least one computer processor, a request to receive in a table an indication of a point value associated with a given task.

10. The method according to claim 1, further comprising:
communicating with a third party comprising at least one of a partner, a provider, a vendor, a merchant, an advertiser, a neighbor, a task assigner, a task reviewer, a supervisor, or an assignor;
wherein said communicating comprising at least one of:
providing access by the third party to at least one of:
at least one wish list;
at least one point balance;
at least one relevant task;
at least one wish list of the assignee;
at least one point balance of the assignee;
at least one relevant task of the assignee;
at least one wish list of the assignor;
at least one point balance of the assignor;
at least one relevant task of the assignor;
at least one wish list of the third party;
at least one point balance of the third party; or
at least one relevant task of the third party;
receiving instructional content;
receiving instructional content on how to perform an associated task;
receiving instructional content from the third party;
receiving instructional content from an assignor;
receiving instructional content from another assignor;
receiving at least one communication from a social network community;
receiving at least one communication from a community;
receiving at least one profile;
receiving at least one request to share at least a portion of at least one profile;
receiving at least one rating from at least one community comprising an assignor, one or more assignees, or a third party;
receiving a sensor based indication;
receiving a passive sensor based task assignment;
receiving an indication of completion of a task by passive sensor;
receiving an indication of a queue of a list of potential tasks for user selection or assignment;
receiving a social media community profile;
receiving a posting or rating;
receiving a request to transfer at least a portion of a point system value;
receiving a request to transfer at least a portion of a point system value in exchange for a 3P partner value;
receiving a request to transfer at least a portion of a point system value into an online commerce company gift card value; or
receiving at least one of:
a coupon, an offer, a deal, a bid, a discount from at least one of: a merchant, an online merchant, an offline merchant, or a 3^{rd} party online partner.

11. The method according to claim 1, wherein said receiving said plurality of tasks comprises:
receiving a request to create at least one of said plurality of tasks.

12. The method according to claim 1, wherein said receiving a plurality of tasks comprises:
receiving a request to create at least one task comprising at least one:
receiving a request to receive or capture content of a given task comprising at least one of:
media,
multiple content,
image,
video,
audio,
multimedia,
text,
hyper text,
file,
text instructions, or
picture;
receiving a request to receive or capture content of proof of completion of a given task comprising at least one of:
receiving a request to authenticate comprising capturing proof of completion by the assignee or the assignor;
receiving a request to verify by the assignee or the assignor;
receiving a request to acknowledge completion by the assignee or the assignor; or
receiving a request to confirm by the assignee or the assignor; or
receiving a request to receive or capture at least one instruction related to a given task, comprising at least one of:
capturing from at least one of: the assignor; or another assignor; or
capturing from a third party comprising at least one of: an assignor; another assignor; a community, or vendor.

13. The method according to claim 1, further comprising:
receiving a request to convert at least a portion of said point system value into a monetary value, and further comprising:
providing at least one of:
providing at least one controlled account with preauthorization rules of restrictions for usage of said monetary value; or
providing at least one non-controlled account with no restrictions on use.

14. The method according to claim 1, wherein said receiving said plurality of tasks comprises:
receiving a request to assign at least one task by the assignor to at least one assignee of a plurality of assignees comprising:
receiving a request to assign the at least one task to at least one of said plurality of assignees comprising at least one of:
receiving a request to capture at least one said plurality of assignees to perform the at least one task;
receiving a request to capture or assign a task leader of a plurality of said assignees; or
receiving a proportional division of points for each of a plurality of assignees.

15. The method according to claim 1, further comprising:
receiving a request to capture comprising at least one of:
receiving a request to capture at least one positive action;
receiving a request to capture at least one negative action;
receiving a request to capture at least a passive data collection associated with an action, wherein said capture is received from at least one of:
a sensor;
a MEMS sensor;
a radio frequency identifier (RFID) tag;
a low energy wireless communication device;
a bluetooth device;
a near field communication capable device;
an accelerometer based device; or
a location sensing or triangulation device;
receiving a request to capture at least one code comprising at least one of:
wherein said receiving said at least one code comprises indicating at least one of initiation of, or completion of at least one action or task;
wherein said receiving said at least one code comprises recording initiation or completion of at least one action or task;
wherein said receiving said at least one code comprises playing or recording of video at initiation or completion of at least one action or task;
wherein said receiving said at least one code comprises recording how the at least one action or task was performed;
wherein said receiving said at least one code comprises capturing a proximity to a location, or a distance traveled, determined by a location tracking system to initiate or complete the at least one action performed;
wherein said receiving said at least one code comprises receiving an indication of an identified at least one of a barcode, an RFID tag, a sensor, a MEMS sensor; or a QR code, wherein said code is affixed in a vicinity of a location where a task is to be performed, and is scanned or sensed at initiation or completion of the task;
wherein said receiving said at least one code comprises receiving at least one of a barcode, an RFID tag, a sensor, or a QR code, wherein said code is wherein said code has been affixed to at least one receptacle or device or apparatus related to a task;
wherein said receiving said at least one code comprises receiving a time stamp, receiving an indication of at least one of a kick off, initiation or completion, of a task comprising at least one of providing task details, points available, list of instructions, or list of other tasks to be performed;
wherein said receiving said at least one code comprises receiving an indication of initiation or completion of a task based on a passive data collection apparatus or device from at least one of: a sensor; an RFID tag; a wireless communication device; a MEMS sensor; a BLUETOOTH device; a near field communication equipped device; an accelerometer equipped device; or a location sensing, or triangulation based device;
wherein said receiving said at least one code comprises receiving a passive data collection from at least one micro-electro-mechanical system (MEMS) sensor; or
wherein said receiving said at least one code comprises receiving at least one near field communication based sensor indication.

16. The method according to claim 15, wherein said at least one negative action comprises at least one of:
receiving a request to capture at least one habitual action or a list of habitual action or unwanted behavior by at least one offending assignee and to associate a negative point value to each of said at least one habitual action;
receiving a request to capture from the assignor at least one specific instance of said at least one habitual action or unwanted behavior, or any item on the list of habitual action or unwanted behavior;
receiving a request to capture evidence of at least one instance of said at least one habitual action or unwanted behavior through at least one form of content comprising at least one of:
a media,
a multiple content,
an image,
a video,
an audio,
a multimedia,
a text,
a hyper text,
a file,
a text instruction,
a picture,
a voice,
receiving a request to deduct the associated negative point value from the offending assignee; or
receiving a request to notify the offending assignee of a specific instance of said at least one habitual action or unwanted behavior and the associated negative point value.

17. The method according to claim 15, wherein said receiving a request to capture of at least one positive action by assignees comprises at least one of:
receiving a request to capture an ad hoc or other observation of performance of an instance of a positive, non-assigned task by an assignee;
receiving a request to capture an observation of an instance of a positive action of the assignee that demonstrates a behavior of deserved merit;
receiving a request to deposit points, or depositing in a points system account of the assignee of a points system value received from the assignor; or
receiving a request to notify or notifying the assignee of the specific instance of positive behavior and the points system value received by the assignor.

18. The method according to claim 1, further comprising:
receiving a request to modify points system value for a given task comprising at least one of:
receiving a base point value for said given task;
receiving rules that may modify the base point value for said given task;
storing rules in at least one database table;
comparing rules with the outcome of the task;
calculating a modification to the baseline point value for said given task;
displaying the modified point value for said given task to at least one of the assignee, or assignor;
receiving an adjustment of the assignor to the base or modified point value of said given task of the assignee resulting in the final point value of said given task;
receiving an increase or bonus in the points value system for completion of a task at least one of: prior to, or by a deadline;
receiving a decrease in the points value system for completion of a task after a deadline;
receiving an indication of completion, or initiation of a task;
receiving an indication of completion or initiation of a task based on sensed information;
receiving a scanned code associated with a task,
wherein said scanned code comprises at least one of:
a barcode,
a multiple dimension barcode,
an radio frequency tag (RFID) tag,
a passive sensor,
a MEMS sensor,
a location based sensor,
an accelerometer based sensor, or
a QR code; or
depositing the final point value of said given task in the points value system account of the assignee.

19. The method according to claim 1, further comprising:
receiving or providing a status of a given task comprising at least one of:
receiving or providing a current status of at least one or all tasks;
comparing the status of at least one or all tasks with a table of at least one rule;
performing at least one calculation based on at least one rule;
capturing at least one time stamp;
measuring time between at least two time stamps of a status change of at least one task;
displaying at least one message;
receiving a request to prioritize at least one task;
receiving a request to designate an order to perform a plurality of tasks;
receiving a request to perform a task before a deadline; or
sending at least one reminder or alert based on at least one rule associated with the status.

20. A system comprising:
at least one memory; and
at least one computer processor coupled to said at least one memory,
wherein said at least one computer processor is adapted to:
receive a plurality of tasks,
wherein each of said plurality of tasks is assigned by an assignor to be performed by an assignee; and
manage a point system associated with completion of said plurality of tasks.

21. A computer program product embodied on a nontransitory computer accessible medium, comprising program logic, which when said program logic is executed on at least one computer processor performing a method comprising:
receiving, by at least one computer processor, a plurality of tasks,
wherein each of said plurality of tasks is assigned by an assignor to be performed by an assignee; and
managing, by the at least one computer processor, a point system associated with completion of said plurality of tasks.
